(19) United States
(12) Patent Application Publication
(10) Pub. No.: US 2001/0017718 A1
(43) Pub. Date: Aug. 30, 2001

(54) Film image reading device and storage medium which stores the control process for the film image reading device

(75) Inventors: Takahiro Ikeda, Toshima-ku (JP); Toshiya Aikawa, Yokohama-shi (JP)

Correspondence Address: OLIFF & BERRIDGE, PLC, P.O. Box 19928, Alexandria, VA, 22320, US

(73) Assignee: NIKON CORPORATION

(21) Appl. No.: 09/745,738

(22) Filed: Dec. 26, 2000

Related U.S. Application Data
(63) Continuation of application No. 08/881,744, filed on Jun. 24, 1997, now abandoned.

(30) Foreign Application Priority Data
Jun. 24, 1996 (JP) HEI 8-163197
Apr. 1, 1997 (JP) HEI 9-82932

(51) Int. Cl. H04N 1/393

(52) U.S. Cl. 358/475; 358/451

(57) ABSTRACT

A film reading image device includes a data generation device to generate index display setting field data by receiving output from an image reading device. The film reading image device further includes a size data obtaining device to obtain size data of the monitor screen of the host apparatus and a control device to set the reading resolution based on the relationship between the number of frames to be index displayed on the monitor screen of the host apparatus and the size data obtained. The image reading device executes conversion operations with the resolution set.

### INCORPORATION BY REFERENCE

The disclosures of the following priority application(s) are herein incorporated by reference: Japanese Patent Application No. Hei 8-163197 filed Jun. 24, 1996, and Japanese Patent Application No. Hei 9-82932, filed Apr. 1, 1997.

### BACKGROUND OF THE INVENTION

1. Field of Invention

The invention relates to a film image reading device and a storage medium which stores control procedures for the film image reading device.

2. Description of Related Art

A film scanner is a film image reading device which reads the image of the film shot by a camera. Such a film scanner is used to read an image of a negative film or a reverse film. The film scanner transmits this data to a host apparatus, such as a personal computer.

Image reading devices are divided into transmission type and reflection type. In the transmission type, the transmission light of the film original is given to the image reading means (hereafter “line sensor”). In the reflection type, the reflection light of the film original is given to the line sensor. In either case, the film original is made to move relative to the line sensor or the line sensor is made to move relative to the film original.

The line sensor is composed of an image accumulation unit and a transfer unit. The image accumulation unit is a plurality of photo-electric conversion units arranged in a row, and the transfer unit transfers electric charges which are accumulated in each of the image accumulation units. In the line sensor, transferring of the electric charge accumulated in each of the image accumulation units to the transfer unit is executed sequentially from one end of the line sensor to the other end in a length direction. Scanning of the electric charge to an external apparatus is also carried out using the same process. The image reading scanning is defined as a main scanning and the direction of the scanning is defined as a main scanning direction.

Image in the image memory region of the film is read by moving the film original and the line sensor by relative to a subscanning direction. The subscanning direction is perpendicular to the main scanning direction.

Incidentally, a new standard film is proposed, called a long film (hereafter “roll film”). The roll film may be handled without being taken out of the cartridge, even after development of the film. Magnetic information may also be added to the roll film. Thus, an index display image data enabling a preview of the images in each frame of the roll film may be generated (in a film image reading device). The index display image data is sent to a host apparatus and is displayed on a monitor screen.

However, the display size of the frame, which displays the index display, may become large of small depending on the relationship between the number of frames in the roll film and the size of the monitor screen of the host apparatus. If the reading resolution is defined independent of the display size, the quality of the display image changes with the size of the monitor screen. Thus, it is desirable to generate index display image data in the film image reading device which handles the roll film.

The index display image data takes into consideration the size of the monitor screen of the host apparatus. If the monitor screen of the host apparatus is a black and white display, generation of the index display image data and main scan image data for color display use by the film image reading device becomes meaningless.

### SUMMARY OF THE INVENTION

The invention resolves such problems by providing a film image reading device and a storage medium which stores control procedures for the film image reading device. The film image reading device is capable of reading the film image corresponding to the characteristics of the monitor screen of the host apparatus to be connected.

Reading of film image corresponding to characteristics of the monitor screen of the host apparatus to be connected is achieved in the invention. This invention accomplishes this task by use of: (i) an illumination device, (ii) an image reading device; (iii) a moving device, (iv) a size data obtaining device, (v) a control device and (vi) a storage medium.

In general, the size data obtaining device obtains the size data for the monitor screen of the host apparatus. The control device sets resolution. The image reading device performs a conversion operation and a display color obtaining device obtains the number of display colors for the monitor screen of the host apparatus. The control device, among other functions, instructs the image reading device to convert the image of each image memory region of the film original with the number of display colors which is consistent with the number of display colors obtained by the display color obtaining device.

The film image reading device sets a reading resolution to obtain the optimum display size of a frame based on the relationship between the size of the monitor screen of the host apparatus and the number of frames to be index-displayed on the monitor screen.

Thus, the image of each frame in the index field to be displayed on the monitor screen is displayed with the appropriate resolution corresponding to each monitor size. Additionally, when the monitor screen of the host apparatus to be connected is a black and white display, reading with much faster speed may be executed compared to the case of color display.

### BRIEF DESCRIPTION OF THE DRAWINGS

FIG. 1 is a structural diagram of an image reading apparatus of one embodiment of the present invention;

FIG. 2 is an external view of a long film (roll film);

FIG. 3 is a flow chart of the initial operation in one embodiment of the present invention;

FIG. 4 is a flow chart of the initial operation in one embodiment of the present invention;

FIG. 5(a) is a drawing describing selection field at the time of starting initial operation;

FIG. 5(b) is a drawing describing the selection field after the initial operation;

FIG. 6 is a drawing describing an example of film information automatic setting field display;

FIG. 7 is a drawing describing an example of film information manual setting field display;

FIG. 8 is a drawing describing an example of an index display setting field;

FIG. 9 is a drawing describing an example of an index display setting field;

FIG. 10 is a drawing describing an example of an index display setting field;

FIG. 11 is a drawing describing the relationship between exposure amount and concentration of a negative film;

FIG. 12 is a drawing describing concentration distribution based on an ideal exposure time;

FIG. 13 is a drawing describing concentration distribution, when exposure time is too long;

FIG. 14 is a drawing describing concentration distribution, when exposure time is too short;

FIG. 15 is a flow chart of the index display data generation process in one embodiment of the present invention (index display of image only);

FIG. 16 is a flow chart of the index display data generation process in one embodiment of the present invention (index display of image only);

FIG. 17 is a flow chart of the index display data generation process in one embodiment of the present invention (index display of image only);

FIG. 18 is a flow chart of the index display data generation process in one embodiment of the present invention (index display of magnetic information only);

FIG. 19 is a flow chart of the index display data generation process in one embodiment of the present invention (index display of magnetic information only);

FIG. 20 is a flow chart of the index display data generation process in one embodiment of the present invention (index display of magnetic information and image);

FIG. 21 is a flow chart of the index display data generation process in one embodiment of the present invention (index display of magnetic information and image);

FIG. 22 is a flow chart of the index display data generation process in one embodiment of the present invention (index display of magnetic information and image);

FIG. 23(a) is a time chart for color reading;

FIG. 23(b) is a time chart for black and white reading;

FIG. 24(a) is a time chart for color reading;

FIG. 24(b) is a time chart for black and white reading;

FIG. 25 is a time chart of the image reading by white-light and RGB filter switching (in the case of three path color reading);

FIG. 26 is a time chart of the image reading by white-light and G filter switching (in the case of black and white reading);

FIG. 27 is a diagram describing an example of a display of image only index display field;

FIG. 28 is a diagram describing an example of a display of designated frame index display field;

FIG. 29 is a diagram describing an example of a display of magnetic information only index display field;

FIG. 30 is an enlarged diagram of a frame of magnetic information only index display field;

FIG. 31 is a diagram describing an example of a display of magnetic information and image index display field;

FIG. 32 is an enlarged diagram of a frame of magnetic information and image index display field;

FIG. 33 is a diagram describing a method of setting reading resolution;

FIG. 34 is a diagram showing an image reading range;

FIG. 35 is a diagram describing reading operation;

FIG. 36 is a diagram describing an interpolation method;

### DETAILED DESCRIPTION OF PREFERRED EMBODIMENTS

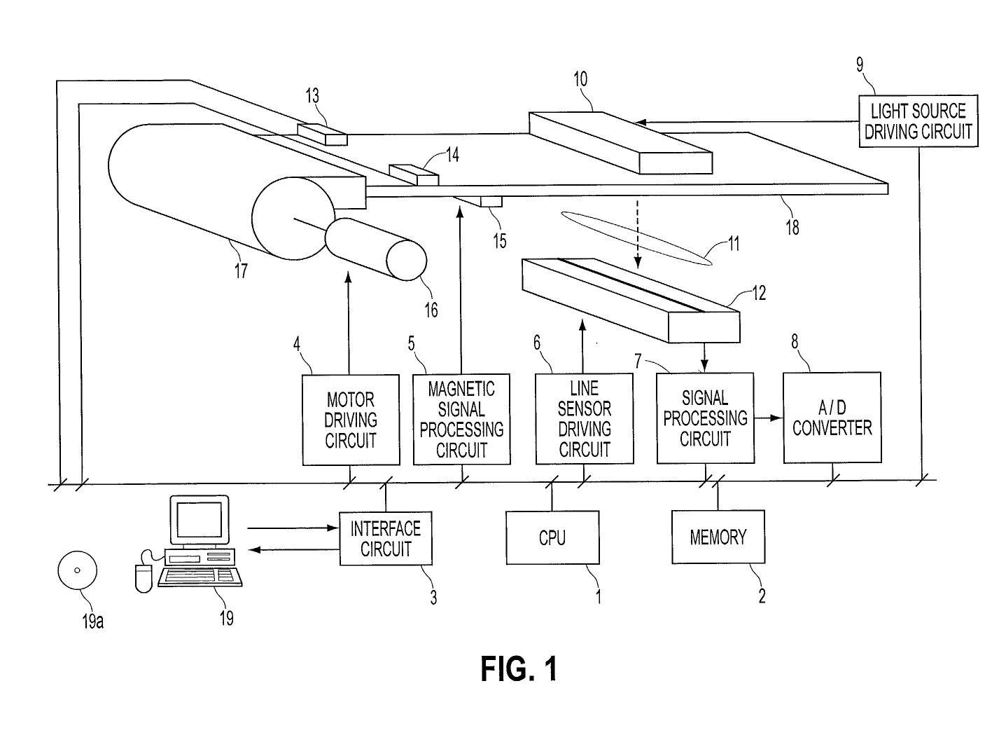

FIG. 1 is a structural diagram of the image reading apparatus. The image reading apparatus comprises a central processing unit (CPU) 1, a memory 2, an interface circuit (IF circuit) 3, a motor driving circuit 4, a magnetic signal processing circuit 5, a line sensor driving circuit 6, a signal processing circuit 7, an A/D converter 8, a light source driving circuit 9, a light source 10, a lens 11, a line sensor 12, a medium position detection sensor 13, an optical information reading sensor 14, a magnetic head 15, a mounting chamber to mount a motor 16 and other various components, a cartridge 17 and a transport path for a roll film. The IF circuit 3 is connected to the host computer 19.

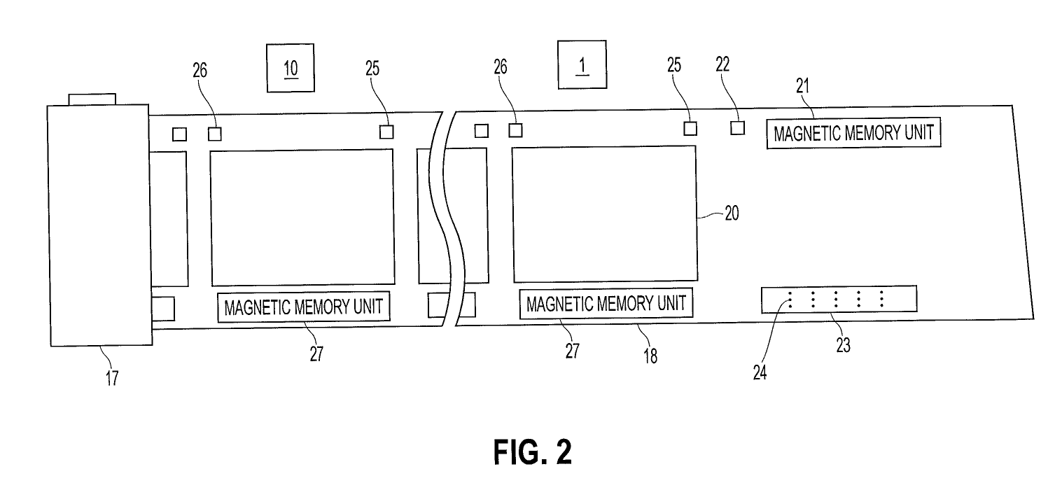

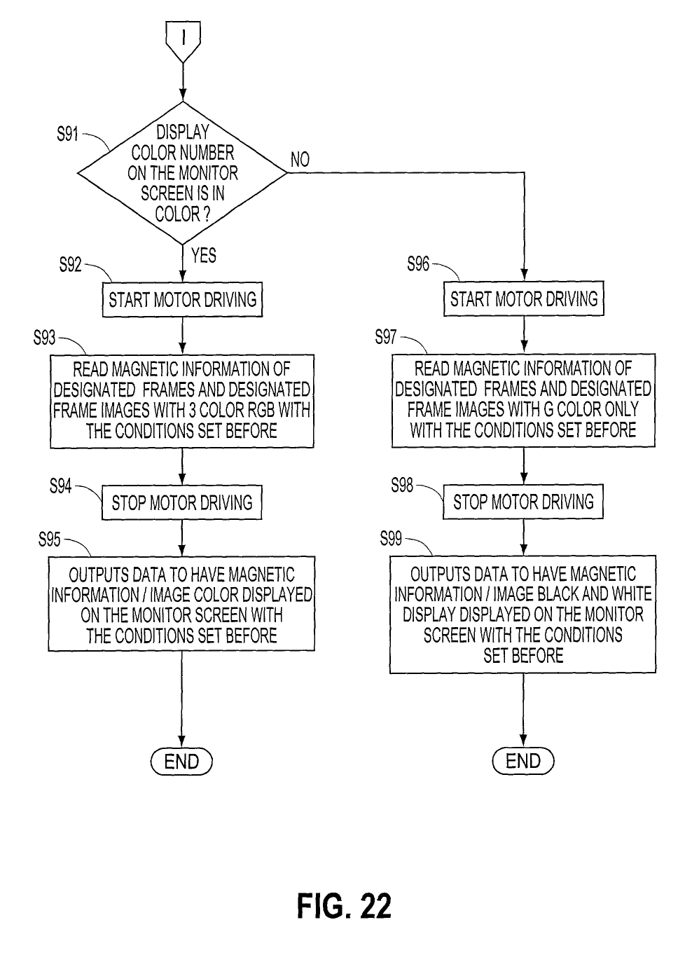

FIG. 2 is an external view of the roll film. In FIG. 22 the roll film 18 is in the process of being scrolled from the cartridge 17. Specific regions in the tip edge (pulling edge) of the roll film 18 are defined as a lead unit. An image memory region 20 of each frame is arranged at a predetermined interval behind the lead unit. A magnetic memory unit 21 and a perforation 22 are provided (in the lead unit along one edge side in the width direction of the film). A magnetic memory unit 23 and a bar code 24 are provided in the lead unit along the other side edge (in the width direction of the film). Two perforations 25 and 26 are provided outside of the image memory region 20 along one edge of the film 18. A magnetic memory unit 27 is provided outside of the image memory region 20 along the other edge of the film 18.

Film information (of the film) is stored in the magnetic memory units 21 and 23. The bar code 24 displays film information of the film by concentration difference. The film information includes a type and model of the film, frame number, total number of frames and other relevant information. The type of the film indicates whether the film is color or black and white, whether the film is positive or negative and other features of the film.

The magnetic memory unit 27 records information concerning shooting, such as title, shooting date, shooting conditions and the designated print size. The camera writes in the information during shooting, however, no information is recorded in the magnetic memory unit 27 if a camera does not have magnetic “write-in” function. The information may also be written in during development.

Usually, a film manufacturer writes information in the magnetic memory units 21 and 23 in the lead unit before shipping the film. However, there may be special situations in which no information is written in the magnetic memory unit 21 and 23 of the lead unit. Designated print size includes a high vision size (H size), a classic size (C size) and a panorama size (P size). The aspect ratio is 16:9 for H size, 3:2 for C size and 3:1 for P size.

The user mounts a cartridge 17 in the mounting chamber 16. Then the spool of the cartridge 17 is connected to the axle of the motor 16. The user closes the lid of the mounting chamber. Then the power source is supplied to each circuit so that each circuit can be started.

The motor driving circuit 4 controls rotational velocity, rotational direction, stopping and other functions of the motor 16 according to instructions from the CPU 1. When the motor 16 is driven in a normal direction, the roll film 18 is scrolled from the cartridge 17 to the transport path. When the motor 16 is driven in a reverse direction, the roll film 18 is wound from the transport path into the cartridge 17.

The medium position detection sensor 13 optically detects each perforation and sends the information to the CPU 1. In particular, the optical information sensor 14 may read bar-codes containing the film information and send that information to the CPU 1. The magnetic head 15 reads the magnetic information of the magnetic memory units 21, 23 and 27 under the control of the magnetic signal processing circuit 5. The magnetic head 15 sends this information to the CPU 1. The magnetic head 15 writes information into the magnetic memory units 21, 23 and 27 under the control of the magnetic signal processing circuit 5.

The magnetic signal processing circuit 5 digitizes the magnetic information read by the magnetic head 15 and sends digitized information to the CPU 1 under the control of the CPU 1. Moreover, the magnetic signal processing circuit 5 sends the magnetic head 15 information to be written in the magnetic memory unit 27 under control of the CPU 1.

The light source 10 illuminates one face of the roll film 18 under control of the light source driving circuit 9. The light source 10 is provided with three colors of light emitting diodes (hereafter LED) such as R (red), G (green) and B (blue). In this case, the light source driving circuit 9 controls turning on and off of the three color LED of the light source 10. The light source 10 may also be a white-color light source. In this case, R(red), G(green) and B(blue) filters may be provided. A switching mechanism for filtering of the three colors is necessary if the three color filter is provided.

The lens 11 is adjusted and arranged to lead the light rays from the light source 10 transmitting the roll film 18 to the light receiving surface of the line sensor 12.

The line sensor 12 is provided with an image accumulation unit. The image accumulation unit is a plurality of photo-electric conversion units, arranged in a row, and a transfer unit. The transfer unit transfers electric charge accumulated in each image accumulation unit. The line sensor 12 is positioned so that the light receiving surface of the image accumulation unit is arranged perpendicular to the direction of the movement of the roll film 18.

The line sensor 12 is either a black and white image sensor or a color image sensor. The light source 10 used for the black and white image sensor is a light source which switches three colors of R(red), G(green) and B(blue) or a white-color light source. The light source 10 which is used for a color image sensor is a white-light light source.

The line sensor driving circuit 6 executes control operation under direction of the CPU 1. The line sensor driving circuit 6 controls accumulation operation and accumulation time of the line sensor 12. Moreover, the line sensor driving circuit 6 controls the main scanning operation. The main scanning operation discharges the accumulated electric charge (image signals/electric signals) to the signal processing circuit 7.

The signal processing circuit 7 amplifies the signals from the line sensor 12, executes signal processing and sends the result to the A/D converter 8. The signal processing performs CDS (correlated double sampling), shading correction, dark current correction and even-odd correction.

The A/D converter 8 converts the image signals into digital signals with predetermined bit numbers. The A/D converter sends the converted signals to the CPU 1. The bit width may be an eight bit.

The CPU 1 executes control operations according to the program which is set in the memory 2. The CPU 1 controls the motor driving circuit 4, the magnetic signal processing circuit 5, the line sensor driving circuit 6, the light source driving circuit 9 and executes reading of the roll film 18. The CPU 1 sets the accumulation time and allows the line sensor 12 to accumulate electric charge according to the exposure conditions which are obtained from the host computer 19.

Next, the CPU 1 executes position detection of perforation and decoding of the contents of the bar-codes based on outputs from the medium position detection sensor 13 and the optical information reading sensor 14. The CPU 1 takes in magnetic information and film image. The magnetic information and film image are read by controlling the magnetic signal processing circuit 5, signal process circuit 7 and the A/D converter 8. It then stores them in the memory 2. At this time, the CPU 1 stores the line data (e.g. image data) equivalent of one or several frames which are read in the memory 2 as line data of R(red), G(green) and B(blue) colors. The CPU 1 can also store the line data equivalent of one or several frames which are read in the memory 2 as one of the line data of R(red), G(green) and B(blue) colors. This operation sets the reading resolution based on the number of frames and the screen size.

The CPU 1 obtains data (e.g. screen size, display color numbers) concerning the monitor screen from the host computer 19 through IF circuit 3. The CPU 1 obtains exposure condition setting data, which is set by the user on the monitor screen, from the host computer 19 through IF circuit 3.

The memory 2 consists of a program memory and a working memory. Selection field data and index display setting field data are also stored in the memory 2.

The IF circuit 3 is an SCSI (Small Computer System Interface). The IF circuit 3 outputs the line data stored in the memory 2 to the host computer 19. The IF circuit 3 also sends frame designation and other commands and monitor screen information from the host computer 19 to the CPU 1.

The host computer 19 has a monitor (e.g., display apparatus), a keyboard (e.g., input device), a mouse and other peripheral devices. The host computer 19 displays the image data received from the IF circuit 3 to the monitor. Moreover, the host computer 19 sends the commands, which are input from the keyboard and the mouse, to IF circuit 3. The host computer 19 comprises a central processing unit, program memory, working memory, hard disk drive and other components. The host computer 19 can accommodate programs which are stored in storage medium 19a, such as CD-ROM.

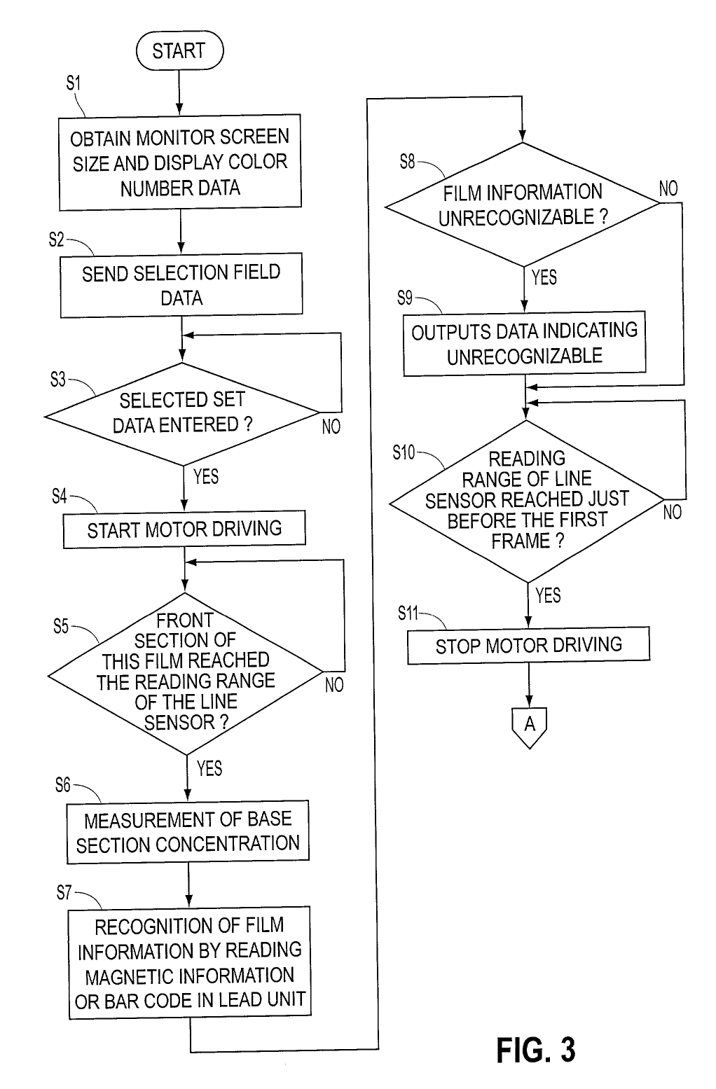

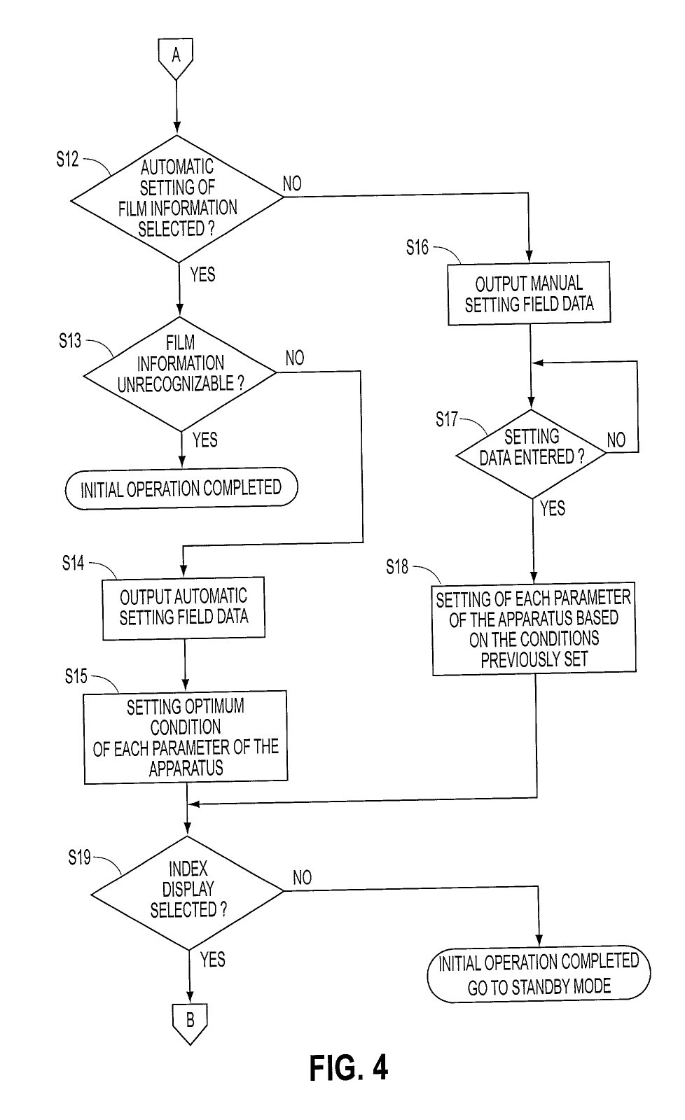

In the illustrated embodiments, the image reading device controller implemented as a single special purpose integrated circuit (e.g., ASIC) having a main or central processor section for overall, system-level control, and separate sections dedicated to performing various different specific computations, functions and other processes under control of the central processor section. It will be appreciated by those skilled in the art that the controller can also be implemented using a plurality of separate dedicated or programmable integrated or other electronic circuits or devices (e.g., hardwire electronic or logic circuits such as discrete element circuits, or programmable logic devices such as PLDs, PLAs, PALs or the like). The controller can also be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the flowcharts shown in FIGS. 3, 4 and 15-24 can be used as the controller. As shown, a distributed processing architecture is preferred for maximum data/signal processing capability and speed.

Referring to FIG. 3, the CPU 1 outputs to the host computer 19 transmission requests and obtains data concerning the size and the display color number on the monitor screen. Various monitor screen sizes such as 640×480, 800×600, 1024×768 are contemplated for use by the invention. Various display colors such as black and white, 16 colors and 16.7 million colors are also contemplated for use by the invention.

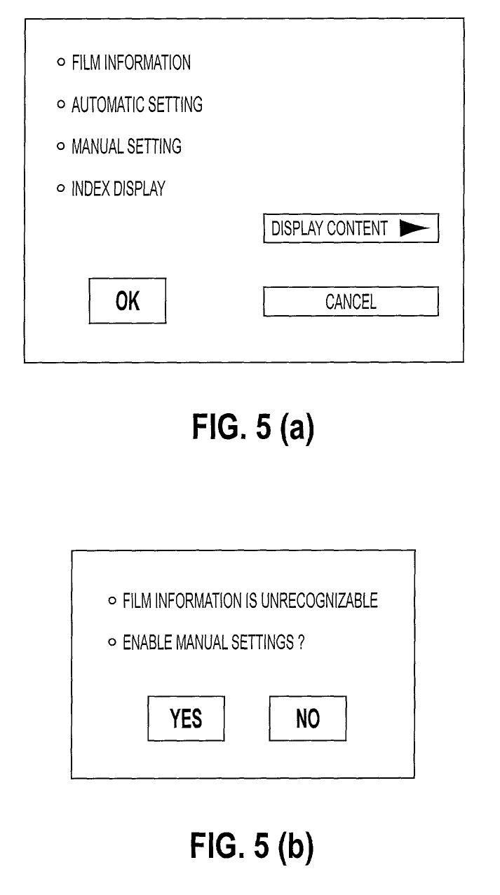

At S1, the CPU 1 determines the size and the display color of the monitor screen based on the data obtained. The CPU 1 extracts the selection field data from the memory 2 at S2, and outputs the data to the host computer 19. As a result, the host computer 19 displays a selection field, described in FIG. 5(a).

Next, the CPU 1 determines at S3 whether or not the data is selected and set data from the host computer 19 is input. If the determination at S3 is affirmative (yes), the CPU 1 starts the operation of the image reading apparatus at S4.

In the selection field, each selection choice of “automatic setting”, “manual setting” and “index display” is displayed with the selection button, as described in FIG. 5(a). Moreover, the selection choice “index display” is displayed with a click button “display content.” “Automatic setting” and “manual setting” enables the apparatus to be automatically or manually set based on the film information.

“Manual setting” is selected, for example, when the user wants to handle the roll film 18 mounted with different specifications or when the roll film 18 is a new product and the information is not provided in the apparatus. In the latter case the roll film 18 must be known to be a new product. “Manual setting” is also set when the roll film 18 is an unknown new product (step S7). In this case, a statement such as “film information cannot be recognized”, is displayed in the selection field, as described in FIG. 5(b). The choice of “manual setting” may be selected after seeing this display.

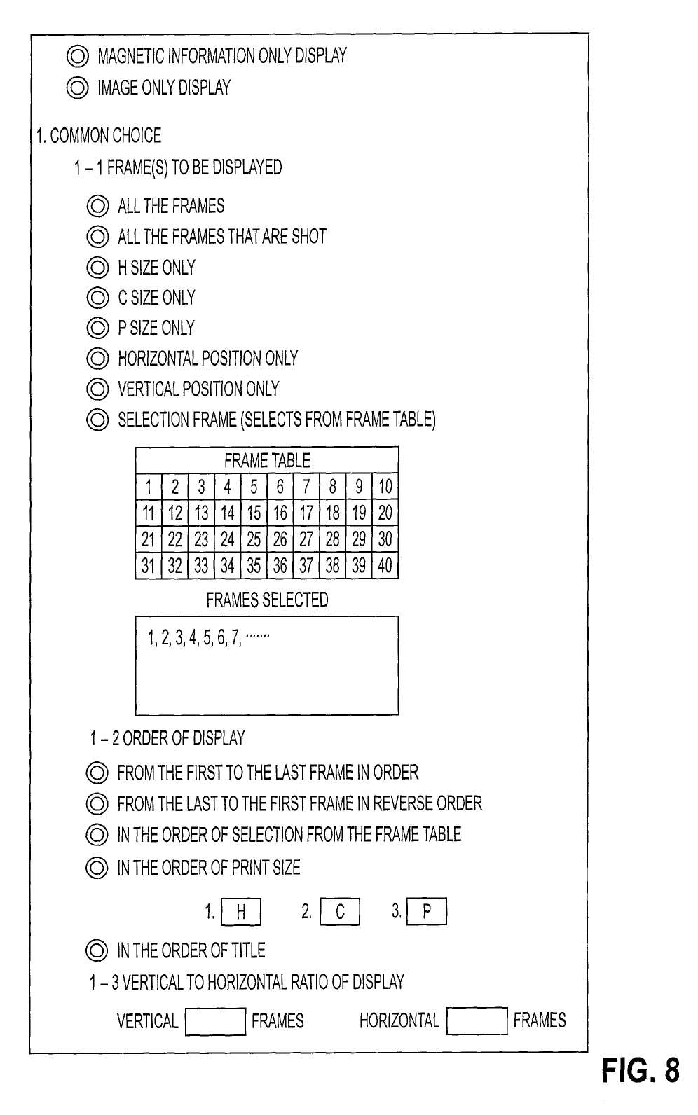

“Index display” allows choice between having the index displayed or not displayed. “Index display” may be made by clicking the mouse on the “index content” button. At this time, the index display setting fields described in FIGS. 8-10 are displayed. The index display setting field data is the data output by the CPU 1 to the host computer 19 as part of the selection field data.

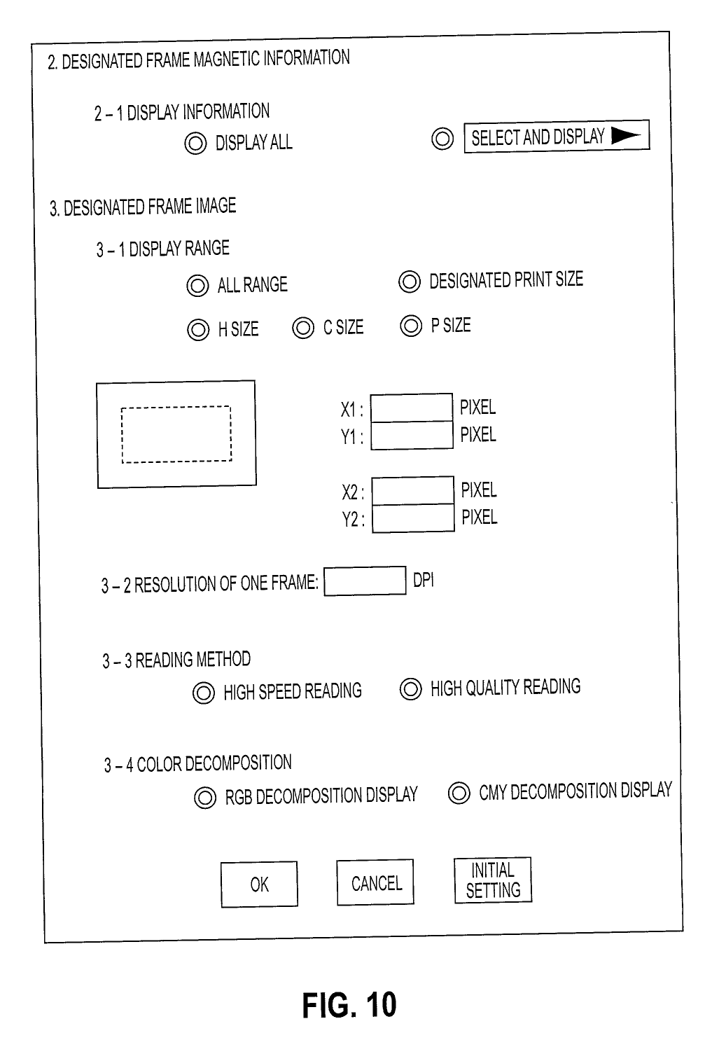

The user may set the-contents of the index display by selecting and setting several choices in the index display setting field as detailed below. In setting the contents of the index display, “initial setting” may be selected (see FIG. 10). In this case, the default value is set. The default value may be set arbitrarily by the user.

Referring to FIG. 8, there are general selection choices of “magnetic information only display” and “image only display” in the index display setting field. When both are selected, “magnetic information and image display” is enabled.

FIGS. 8-10 show “1. Common ”, “2. Designated Frame Magnetic Information” and “3. Designated Frame Image” choices for individual selection choices.

“COMMON CHOICE” includes 6 subchoices, including:

(i) 1-1. The Frame(s) to be Displayed;

(ii) 1-2. The Order of Display;

(iii) 1-3. The Vertical-to-Horizontal Ratio of Display;

(iv) 1-4. The Method of Display;

(v) 1-5. Method of Simultaneous Display of Magnetic Information and Image; and

(vi) 1-6. High Speed Display.

The “Frame(s) to be Displayed” includes the following choices: “All the Frames”, “All the Frames That Are Shot”, “H Size Only”, “C Size Only”, “P Size Only”, “Horizontal Position Only”, “Vertical Position Only” and “Selection Frame”. “Selection Frame” is selected from the frame table. The frame number(s) of the frame(s) selected is displayed in the column under “Frame Selected.”

The “Order of Display” choice includes five subchoices, including: “From the First Frame to the Last Frame in Order,” “From the Last Frame to the First Frame in Reverse Order,” “In the Order of Selection From the Frame Table,” “In the Order of Print Size” and “In the Order of Title.”

To display the selected frames in “The First Frame to the Last Frame In Order” choice, the frames are displayed in ascending order of the frame number. To display the selected frames in “From the Last Frame to The First Frame in Reverse Order”, the frames are displayed in descending order of the frame number.

In the “Order of Selection”, the frames selected in the selection choice “Selection Frame” are displayed according to the order of selection. Frames are displayed “In the Order of Print Size”, in the order of size H, C, P. The print size H, C, P may be designated as “1.H”, “2.C” and “3.P”.

In the “Order of Title Choice”, frames are displayed and differentiated in the order of the title stored in the magnetic memory unit of each frame. In this choice, the images with the same content, such as sports day and field trip, are sorted out and displayed. Thus, the indexed images become very easy to observe.

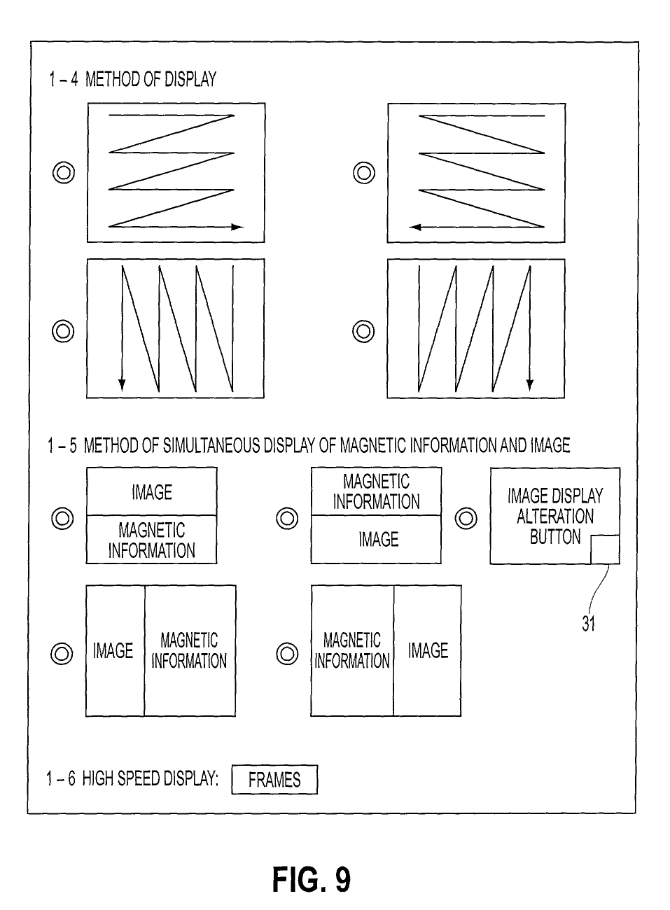

In choice 1-3, “The Vertical-to-Horizontal Ratio of Display”, the user may set the number of frames in the vertical display and the number of frames in the horizontal display. In choice 1-4, “The Method of Display”, one pattern may be selected from four display patterns, as described in FIG. 9.

In choice 1-5, “The Simultaneous Display Method of Magnetic Information and Image”, one method may be selected from five display methods, as described in FIG. 9. One of the display methods displays image only to start. In this case, the display is switched to the magnetic information if the display altering button 31, located in the corner of the display field, is chosen.

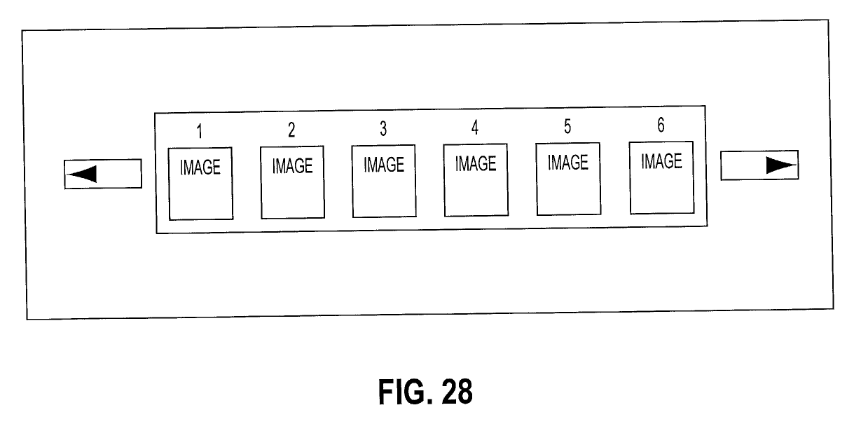

In choice 1-6, “High Speed Display”, the number of frames to be displayed in the field is set. For example, if the user specifies six frames, the first six frames of the frames selected in “Selection Frame” are displayed, as described in FIG. 28. Moreover, if the left and right mouse buttons are clicked the next six frames in the left or the right are scrolled and displayed. In this display only the designated frame number is displayed. Thus, the high speed display is enabled. Moreover, the designated frame number is displayed while scrolling. In this case, the display does not interfere with other displays. Moreover, if the high speed display is selected, the CPU 1 only has to read the designated frames, in which case the CPU 1 is able to generate index display data with high speed.

Only choice 2-1, “The Display Information,” is provided in choice 2, “The Magnetic Information of the Designated Frame”. The user may select to display all or some frames in choice 2-1, “The Display Information,”. In order to display selectively, the user clicks the right arrow button with the mouse. Then, the setting field changes to the selection field which displays the title, shooting data, shooting conditions (existence of strobe, exposure, etc.) and other features. The user may set the desired display in the selection field.

Next, choice 3, “Designated Frame Image”, includes four choices, including:

(i) 3-1. “Display Range,”,

(ii) 3-2. “Resolution of One Frame”,

(iii) 3-3. “Reading Method” and

(iv) 3-4. “Color Decomposition”.

The range of each frame to be displayed is set in choice 3-1, “Display Range”. Settings may be chosen from “Total Range”, “Designated Print Size”, “H size”, “C size”, and “P size”. “H size”, “C size” and “P size” are stored in the magnetic memory unit 27. “Designated Print Size” is set by inputting the pixels of the display range (X1, Y1) and (X2, Y2).

The resolution of the image to be displayed may be designated in 3-2, “Resolution of One Frame”. Either “High Speed Reading” or “High Quality Reading” may be selected in choice 3-3, “Reading Method”.

If choice “High Speed Reading” is selected, the CPU 1 reads the designated frame with accumulation time, stop and constant gamma characteristic of the line sensor 12. The CPU 1 computes the optimum values of accumulation time, stop and gamma characteristics for the line sensor 12 based on the type and model of the film and concentration (base concentration) of the film base material. The base concentration may be found from film information, however, it is an approximate value. In the configuration of the present embodiment the base concentration is measured during initial operation and correction is made, if necessary.

If “High Quality Reading” is selected, the CPU 1 computes optimum accumulation time, stop and gamma characteristics for each designated frame. Moreover, the CPU 1 reads each designated frame with the conditions set above.

Either “RGB Ddecomposition Display” or “CMY Decomposition Display” may be selected in choice 3-4, Color Decomposition”.

The user operates the “OK” button after verifying the contents of the selections and settings. The host computer 19, responding to the operation of the “OK” button, outputs data with contents selected and set by the user to IF circuit 3.

At step S3, the CPU 1 determines if selection/setting data has been entered from IF circuit 3. If the selection/setting data has been entered from IF circuit 3, the CPU 1 determines affirmative (YES). If the selection/setting data has not been entered, the CPU 1 determines negative (NO). The CPU 1 returns to S3 if the determination is negative (NO) at S3. When the CPU 1 determines affirmative (YES) it moves to the next step, S4. The CPU 1 starts rotation drive of the motor 16 which in turn begins a thrust operation.

At S5, the CPU 1 determines if the front section of the film has reached the reading range of the line sensor 12. This determination is made based on the output from the medium position detection sensor 13. The CPU 1 makes an affirmative determination (YES) if the front section of the film reaches reading range of the line sensor 12. The CPU 1 makes a negative (NO) determination if the front section of the film has not reached the reading range of line sensor 12.

If the determination is negative (NO) at S5, the CPU 1 returns to process S5. At this time the CPU 1 waits for the front section of the film to reach the reading range of the line sensor 12. When the determination at S5 becomes affirmative (YES), the CPU 1 moves to S6.

At S6 the CPU 1 measures the base concentration of the film according to output signals of the line sensor 12. At S7 the CPU 1 reads the contents (film information) of the bar code 24 or the magnetic memory of units 21 and 23 of the lead unit. This is based on the output from the optical information reading sensor 14 or the output from the magnetic head 15. Furthermore, the CPU 1 recognizes if the film information of the roll film 18, which is read at S7, may be used as criteria in obtaining accumulation time, stop and gamma characteristics of the line sensor 12.

The CPU 1 is made to execute a process of step S7 based on the determination that the front edge of the roll film 18 has reached the predetermined position at S5. The CPU 1 may also be made to execute the process of S7 based on the detection of the perforation 22 in the front edge of the roll film 18 by the medium position detection sensor 13.

At S8, the CPU 1 determines whether or not the film information of the roll film 18 is recognizable. For example, if the roll film 18 is a new product and the apparatus does not have film information for the film, the CPU 1 makes a determination of “unrecognizable”.

At S8 the CPU 1 makes an affirmative (YES) determination if the film information is unrecognizable and then moves to S9. At S9 the CPU 1 generates and outputs to the host computer 19 display data such as, “Film Information is Unrecognizable”. As a result, the host computer 19 displays a selection field (described in FIG. 5(b)) on the monitor screen. In this selection field statements such as, “Film Information is Unrecognizable” and “Proceed with Manual Setting?” are displayed. This is because the CPU 1 is unable to execute automatic setting if the film information is unrecognizable.

In the selection field of FIG. 5(b) the user operates the “YES” button or “NO” button. The host computer 19 notifies the choice of the user to the CPU 1. Upon receiving the notification, the CPU 1 either changes or maintains the choice made in the selection field of FIG. 5(a). For example, if the user operates the “YES” button in the selection field of FIG. 5(b) while the automatic setting is selected in the selection field of FIG. 5(a), the automatic selection may be changed to manual setting. If the user operates the “NO” button in the selection field of FIG. 5(b) while the automatic setting is selected in the selection field of FIG. 5(a), the automatic setting will be maintained.

Upon completion of the process at S9 the CPU 1 moves to S10. The CPU 1 also moves to S10 if the determination in step S8 is negative (NO). At S10 the CPU 1 determines whether or not the reading range of the line sensor 12 has reached just before the first frame based on the output from the medium position detection sensor 13. The CPU 1 makes a negative (NO) decision if the reading range of the line sensor 12 has not reached just before the first frame. The CPU 1 makes an affirmative (YES) determination if the reading range of the line sensor 12 has reached just before the first frame. If determination in S10 is negative (NO), the CPU 1 returns to the process of S10. The CPU 1 then waits for the reading range of the line sensor 12 to reach just before the first frame.

When the determination at S10 becomes affirmative (YES), the CPU 1 stops driving the motor 16 at S11 and completes the thrust operation. Then the CPU 1 determines whether or not the automatic setting of film information is selected at S12.

The CPU 1 makes an affirmative (YES) determination if the automatic setting of film information is selected. The CPU 1 makes a negative (NO) determination if the automatic setting of film information is not selected.

If the determination at S12 is affirmative (YES), the CPU 1 determines whether or not film information is unrecognizable at S13. This process reconfirms the determination of S8. If the film information is unrecognizable, the CPU 1 makes an affirmative (YES) determination. If the film information is recognizable, the CPU 1 makes a negative (NO) determination.

If the determination is affirmative (YES) at S13, the CPU 1 completes the initial operation because the automatic the setting process cannot be executed. If the determination is negative (NO) at S13, the CPU 1 moves to S14 because the automatic setting process can be executed.

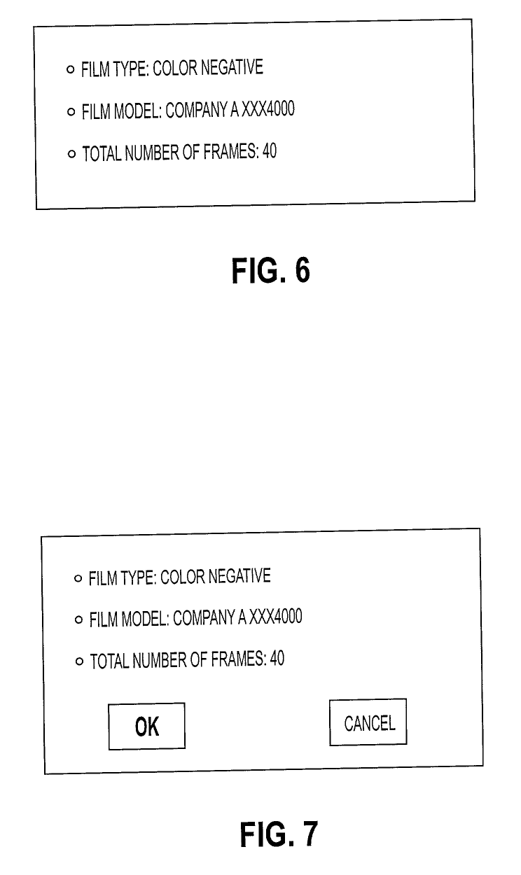

At S14 the CPU 1 outputs automatic setting field data to the host computer 19. As a result, film information automatic setting field is displayed on the monitor screen. In the film information automatic setting field, film type, film model, total number of frames and other relevant information are displayed (as described in FIG. 6). This display is for user verification.

At S15 the CPU 1 sets each parameter of the apparatus to optimal condition of image reading based on the film information read and the film concentration measured. It then moves to S19. For example, these parameters are accumulation time, stop gamma characteristics of the line sensor 12.

If the determination is negative (NO) at S12, the CPU 1 moves to S16. At S16 the CPU 1 outputs the manual setting field data to the host computer 19. As a result, the film information manual setting field (described in FIG. 7) is displayed on the monitor screen. Contents of the display are film type, film model, total frame number and other relevant information, as in the case of the film information automatic setting field. In the film information manual setting field both buttons “OK” and “CANCEL” are displayed together.

The user inputs from the keyboard film type, film model, total number of frames and other information in the film information manual setting field. The user operates the “OK” button if the user wants to have the image reading apparatus execute the parameter setting operation after completion of the settings. The host computer 19 responds to user operation of the “OK” button and outputs the data representing the manual setting by the user to IF circuit 3. The user operates the “CANCEL” button if the user needs to execute resetting by canceling the contents of the setting.

At S17 the CPU 1 determines whether or not the data manual set above by the user is entered. If the manually set data is not entered, the CPU 1 makes a negative (NO) determination. If the manually set data is entered, the CPU 1 makes an affirmative (YES) determination. If the determination is negative (NO) at S17, the CPU 1 returns to the process of S17. When the determination of S17 is affirmative (YES), the CPU 1 executes the process of S18 and moves to S19.

At S18 the CPU 1 sets each parameter of the image reading apparatus to an optimum condition for reading the image, based on manually set film information and measured film concentration. These parameters are accumulation time, stop, gamma characteristics and other relevant information of the line sensor 12.

At S19 the CPU 1 determines whether or not the index display is selected in the selection field, as described in FIG. 5(a). If the index display is selected, the CPU 1 makes an affirmative (YES) determination. If the index display is not selected, the CPU 1 makes a negative (NO) determination.

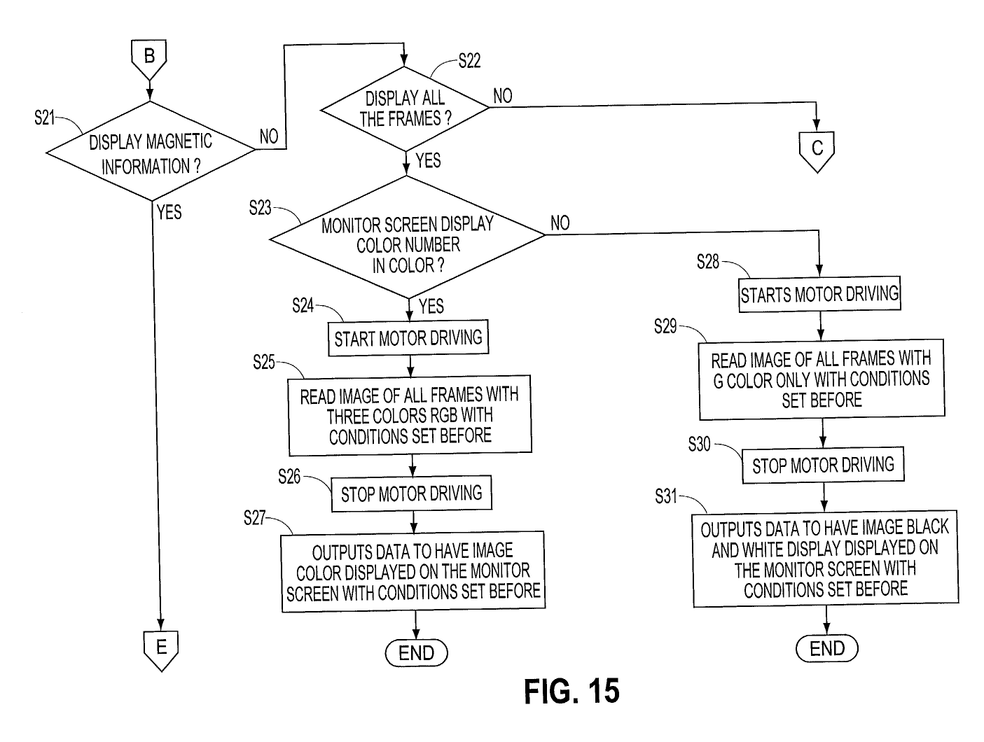

If the determination at S19 is affirmative (YES), the CPU 1 moves towards operation of generating data for index display field (described in FIGS. 15-22). If the determination at S19 is negative (NO), the CPU 1 completes the initial operation and goes into standby mode.

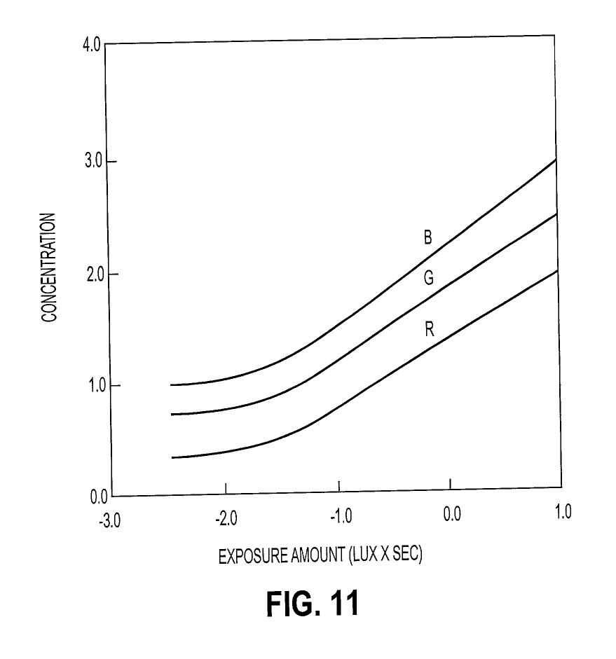

FIG. 11 is a diagram describing the relationship between exposure amount of a negative film and concentration. The horizontal axis represents exposure amount (lux×sec.) while the vertical axis represents base concentration. In FIG. 11, characteristic curves of exposure amount versus concentration for each of R, G and B are shown. In the image reading apparatus the gamma characteristic curve is set in such a manner that the gamma characteristic curve becomes a curve which linearly corrects the characteristic curve of exposure amount versus concentration.

The characteristic curve of exposure amount versus concentration of the film differs by film models. In other words, film X of company A and film Y of company B describe different characteristic curves of exposure amount versus concentration. The film model data is contained in film information which is stored in the magnetic memory unit or the bar code in the lead unit. Hence the gamma characteristic curve needs to be set for each film model according to the film model read from the film information.

The base concentration has dispersion even if the film models are the same. Thus, characteristic curves of exposure amount versus concentration often shift vertically. For this reason, in the case of the film being the same model, the gamma characteristic curve needs to be set to the optimum curve. This is done by measuring the base concentration and by correcting the dispersion amount for each film.

The gamma characteristic curve is stored in the memory 12 for each model of the film. The CPU 1 selects a gamma characteristic curve for each model of the film and deploys the curve to the memory 2. The memory 2 executes a gamma transformation process by the gamma characteristic curve for which image signals (after the A/D conversion) are set.

Reading of images for index display is executed with high speed under constant gamma characteristics. Thus, in reading image for index display, all the frames are read with the gamma characteristics (which are set according to the above method). Initial values for the image reading are the gamma characteristics (which are also set according to the above method). In a normal image reading of all the frames, the gamma characteristics are set according to above the method as long as the characteristics are not changed.

An accumulation time of the line sensor 12 is defined as the time during which the light receptor of the line sensor 12 executes photo-electric conversion by receiving light and accumulates electric charge. A diaphragm value is defined as a level of diaphragm aperture to be arranged between the roll file 18 and the line sensor 12. By adjusting the level of diaphragm aperture, the exposure amount of the line sensor 12 is adjusted. Thus, the exposure amount of the line sensor 12 depends on the accumulation time and the stop of the line sensor 12. In a normal image reading, the concentration distribution is measured for each frame through certain operations, such as pre-scanning.

The exposure time of the main scanning is computed so that the output value of the brightest spot becomes the full scale of the A/D converter 8 (for example, 255 for the 8-bit A/D converter) based on the result of the measurement. The main scanning is executed with the exposure time computed above. Hence the optimum image is obtained.

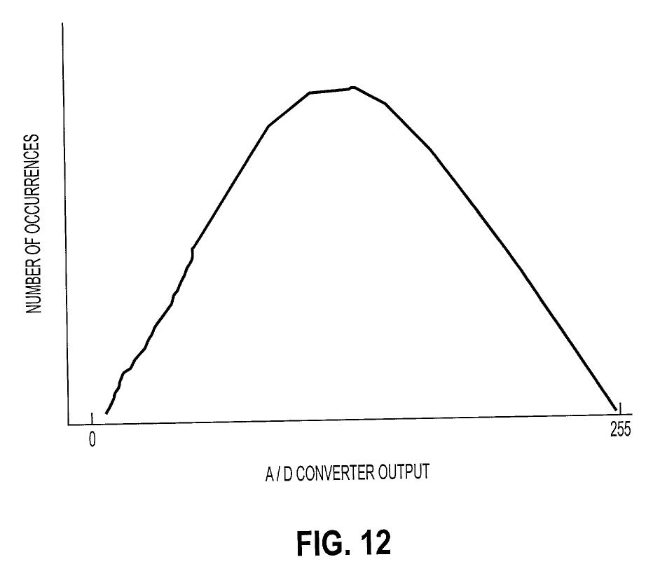

FIGS. 12-14 are measurement diagrams of the concentration distribution. In FIGS. 12-14, the horizontal axis represents the output values (0-255) of the A/D converter 8 while the vertical axis represents frequency of occurrence of each value.

If the exposure time is ideal during pre-scanning, the output value of the brightest spot becomes the full scale of the A/D converter 8 (FIG. 12). This enables an accurate computation of the exposure time during the main scanning. Thus an optimum image is obtained during the main scanning.

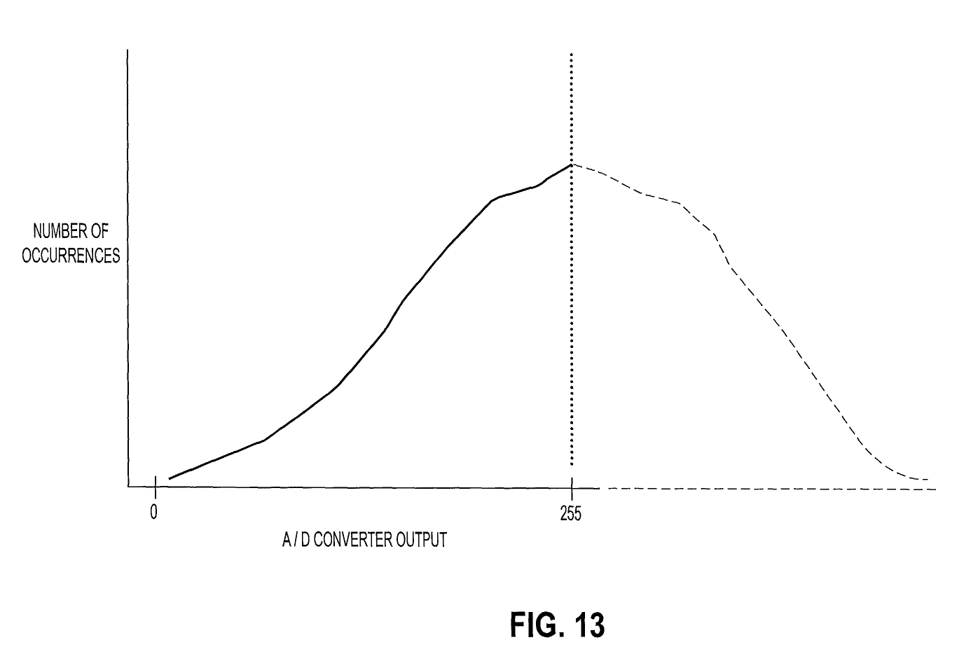

However, if the exposure time during pre-scanning is too long, the value of the bright section of the medium is stuck to 255 (FIG. 13). Thus, an accurate computation of exposure time necessary for the main scanning cannot be executed.

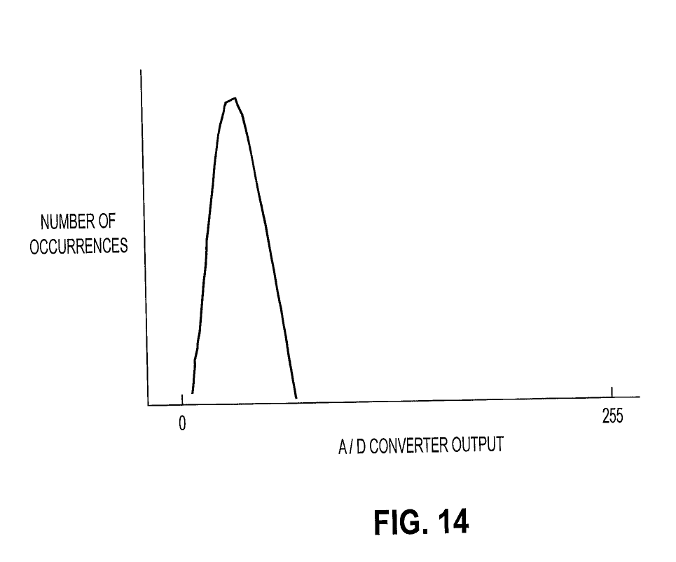

If the exposure time during pre-scanning is too short, the concentration distribution becomes dense around small values (FIG. 14). In this case, quantization error becomes too large and, thus, an accurate computation of exposure time necessary for the main scanning cannot be executed. Therefore, the optimum exposure time during pre-scanning is computed from the film information and the measured base concentration (e.g. base is the brightest spot).

High speed reading with constant exposure amount is executed in the reading of the image for the index display. It becomes necessary to make the accumulation time and the stop of the line sensor 12 constant for all the frames in reading image for the index display. Thus, the exposure amount of the line sensor 12 is determined so that the line sensor 12 does not saturate and the image of an appropriate brightness is obtained from the characteristic curve of the exposure amount versus concentration of the film. A similar concept may be applied to a case of a positive film.

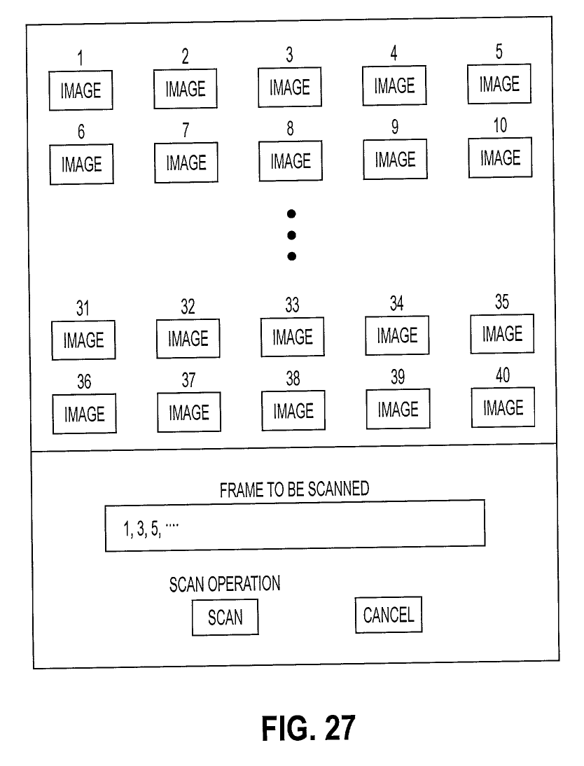

Next, an operation of the CPU 1 to generate and output data for an index display field to the host computer 19 will be described with reference to FIGS. 15-26 and 33-35. FIGS. 27-32 will also be explained.

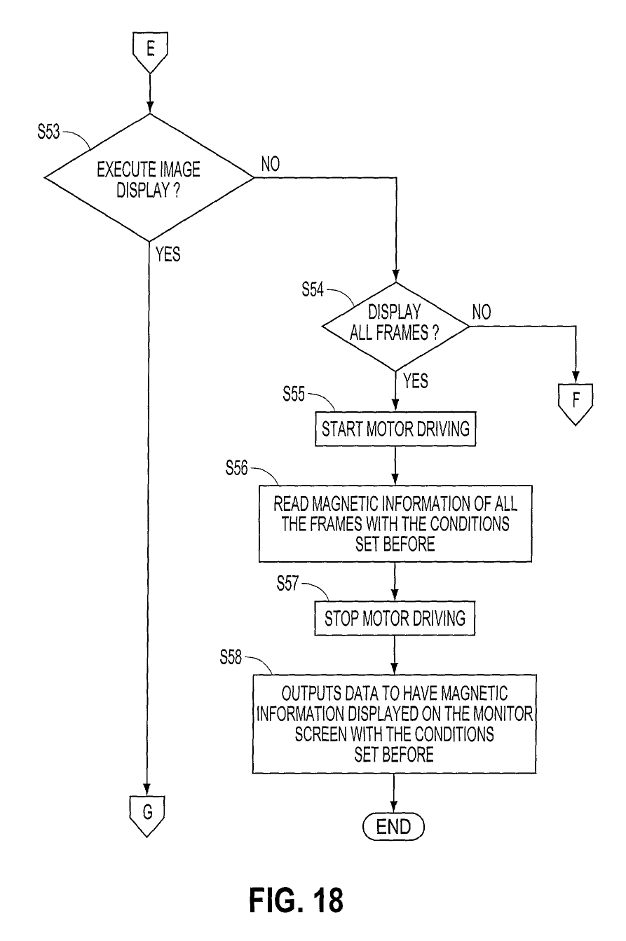

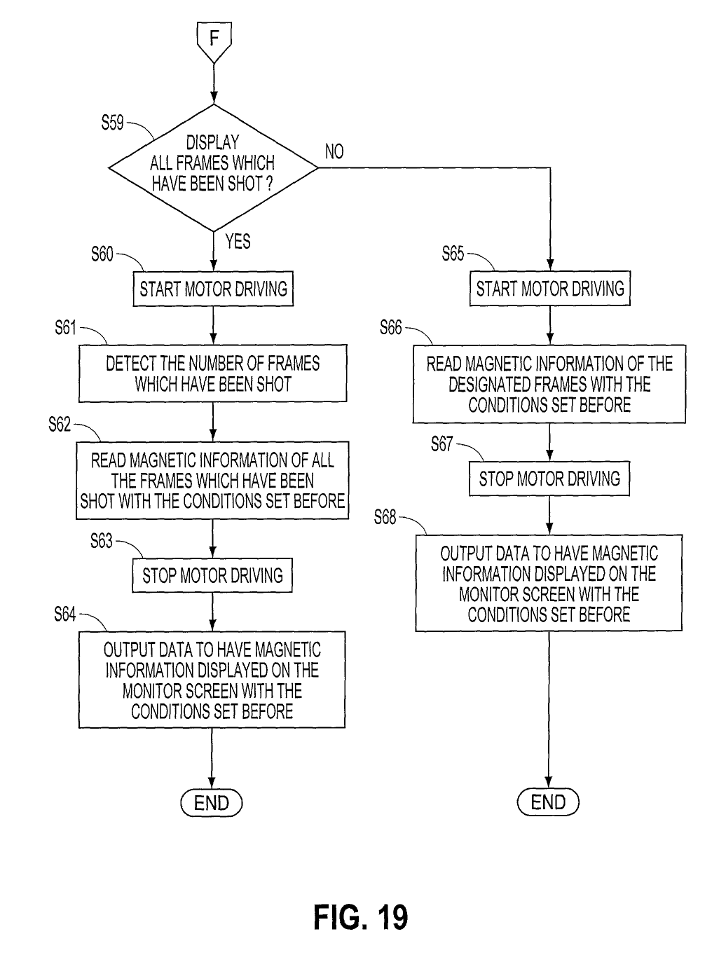

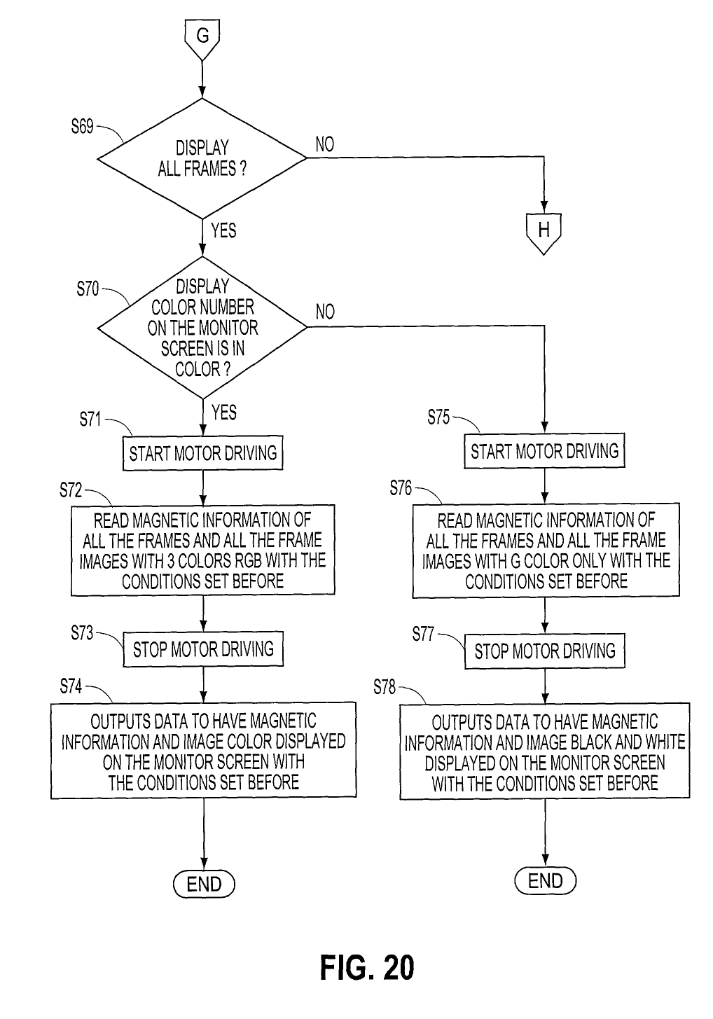

The CPU 1 determines at S21 whether or not “magnetic information display” has been selected in the index display setting field. Based on the result of the determination, the CPU 1 executes the data generation operation for the index display field of image only (FIGS. 15-17), data generation operation for the index display field of magnetic information only (FIGS. 18 and 19) and data generation operation for the index display field of both image and magnetic information (FIGS. 20-22).

At S21 the CPU 1 determines whether or not the “magnetic information display” has been selected in the index display setting field. If the “magnetic information display” is selected, the CPU 1 makes an affirmative (YES) determination. In this case a different operation is executed depending on whether or not the “image display” is selected. If the “magnetic information display” has not been selected, the CPU 1 makes a negative (NO) determination. In this case the CPU 1 indicates that only the “image display” is selected.

If the determination at S21 is affirmative (YES), the CPU 1 moves to S53 (FIG. 18). If the determination at S21 is negative (NO), the CPU 1 executes the image display data generation process of S22-S52.

At S22 the CPU 1 determines whether or not “all frame display” has been selected. If “all frame display” is selected, the CPU 1 makes an affirmative (YES) determination. If “all frame display” has not been selected, the CPU 1 makes a negative (NO) determination.

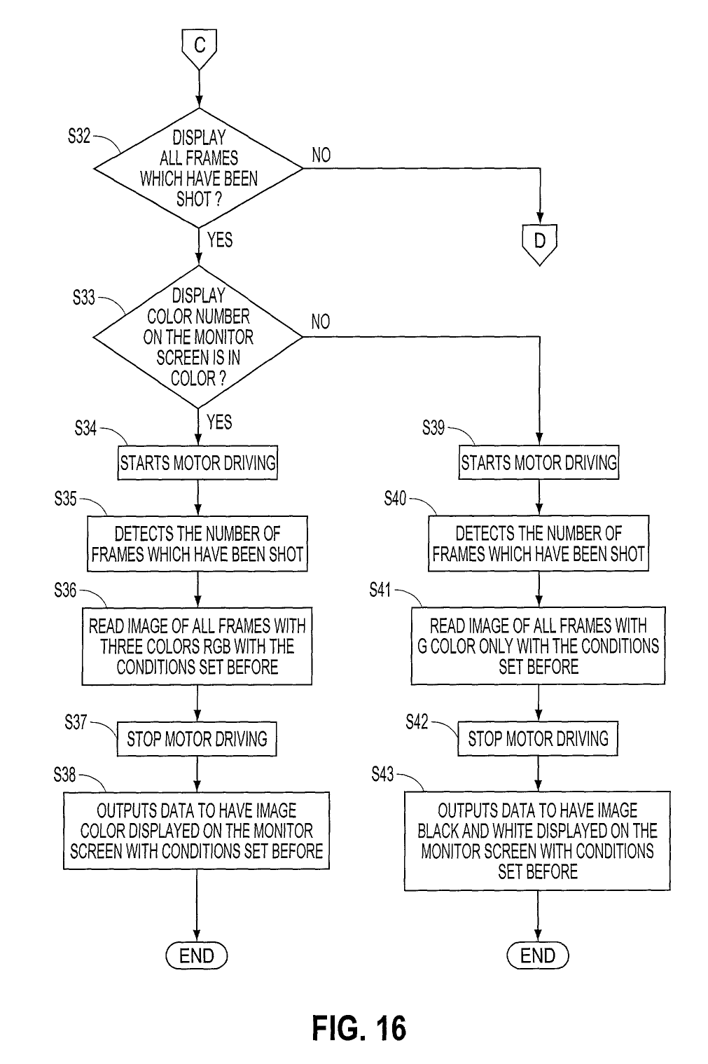

If the determination of S22 is affirmative (YES), the CPU 1 moves to the process at S23. If the determination at S22 is negative (NO), the CPU 1 moves to the process at S32 (FIG. 16). The process at S32 will be explained below.

At S23 the CPU 1 determines whether or not the display color number of the monitor screen is in color. If the display color number of the monitor screen is in color, the CPU 1 makes an affirmative (YES) determination. If the display color number of the monitor screen does not indicate color, the CPU 1 makes a negative (NO) determination. If the determination at S23 is affirmative (YES), the CPU 1 completes the process by executing color image display data generation process for all frames in S24-S27. If the determination at S23 is negative (NO), the CPU 1 completes the process by executing black and white image display data generation process for all frames in S28-S31.

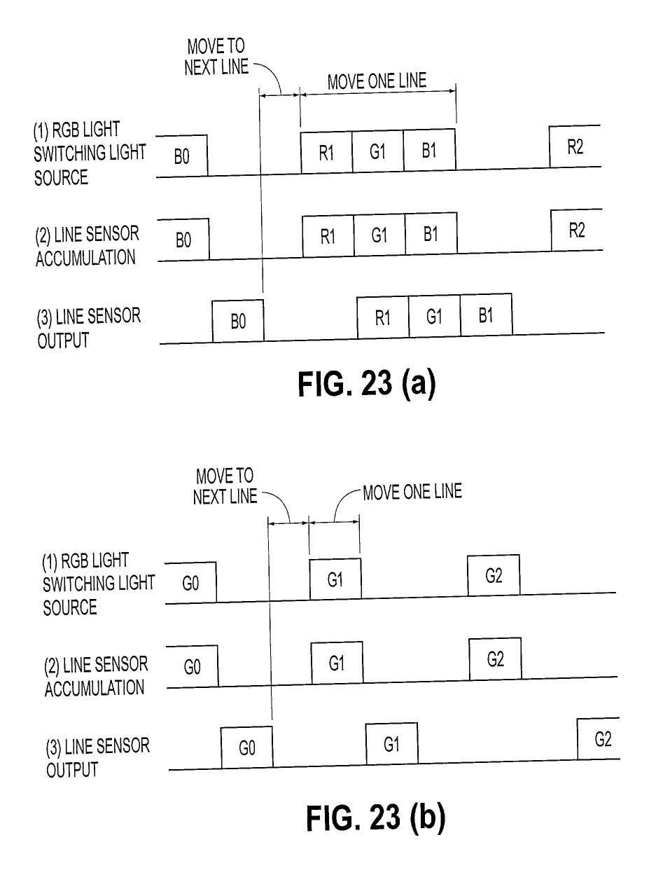

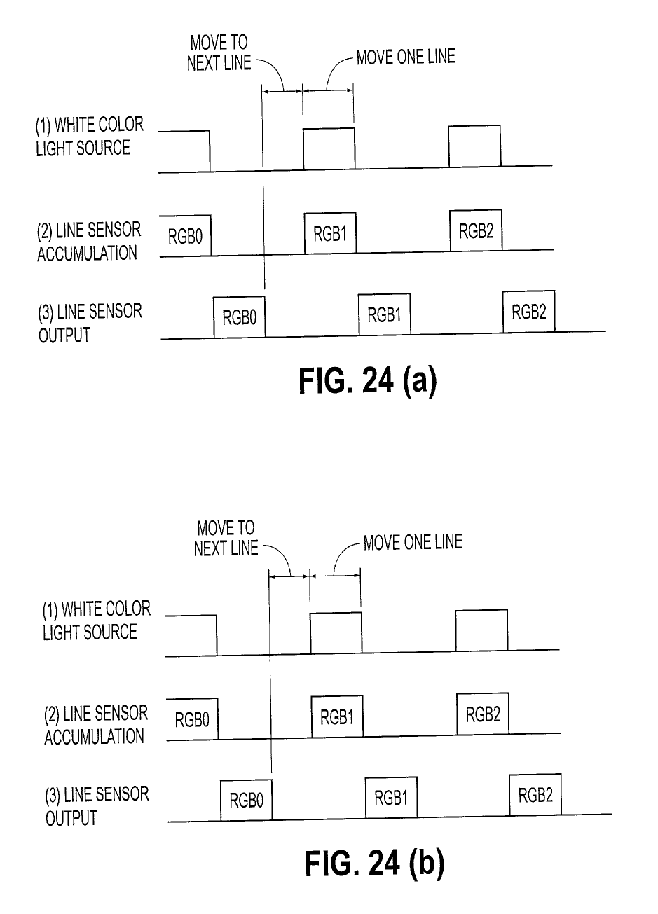

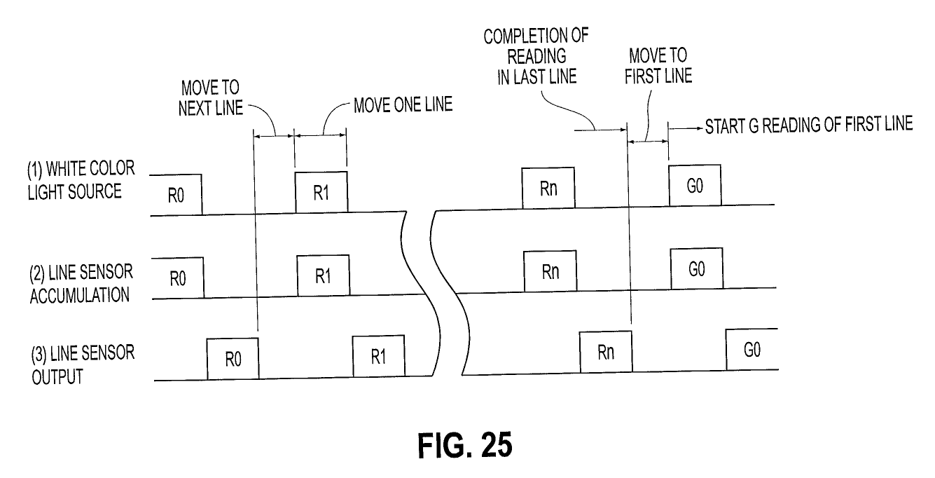

At S24 the CPU 1 begins driving rotation of the motor 16. At S25 the CPU 1 reads image of all the frames in three colors R, G and B, with the condition set before. The method of reading color of the image will be explained in FIG. 23(a), FIG. 24(a) and FIG. 25. At S26 the CPU 1 stops driving rotation of the motor 16. At S27 the CPU 1 outputs image data to be color displayed on the monitor screen to the host computer 19, with the condition set before.

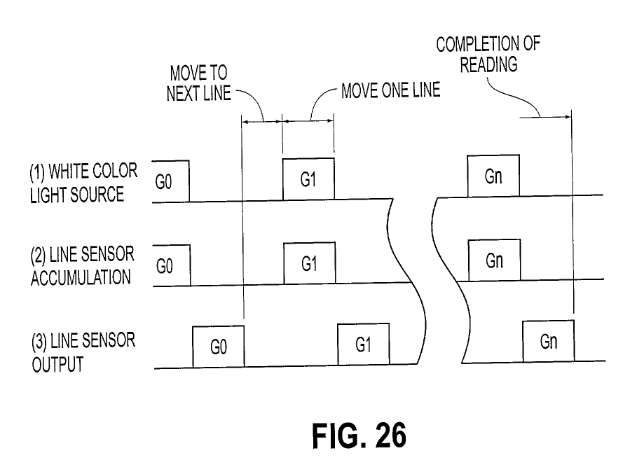

The black and white image display data generation process at S28-S31 is executed as follows. At S28 the CPU 1 begins driving rotation of the motor 16. At S29 the CPU 1 reads the image of all the frames by G color only, with the condition set before. The method of black and white reading of the image will be explained in FIG. 23(b), FIG. 24(b) and FIG. 26.

At S30 the CPU 1 stops driving rotation of the motor 16. At S31 the CPU outputs the image data to be black and white displayed on the monitor screen to the host computer 19 with the condition set before.

At S32 the CPU 1 determines whether or not “display of all frames that are shot” has been selected. If the “display of all frames that are shot” has been selected, the CPU 1 makes an affirmative (YES) determination. If the “display of all frames that are shot” has not been selected, the CPU 1 makes a negative (NO) determination. In this case the choice of “selection frame” has been selected, which indicates the process for the designated frame being selected is to be executed.

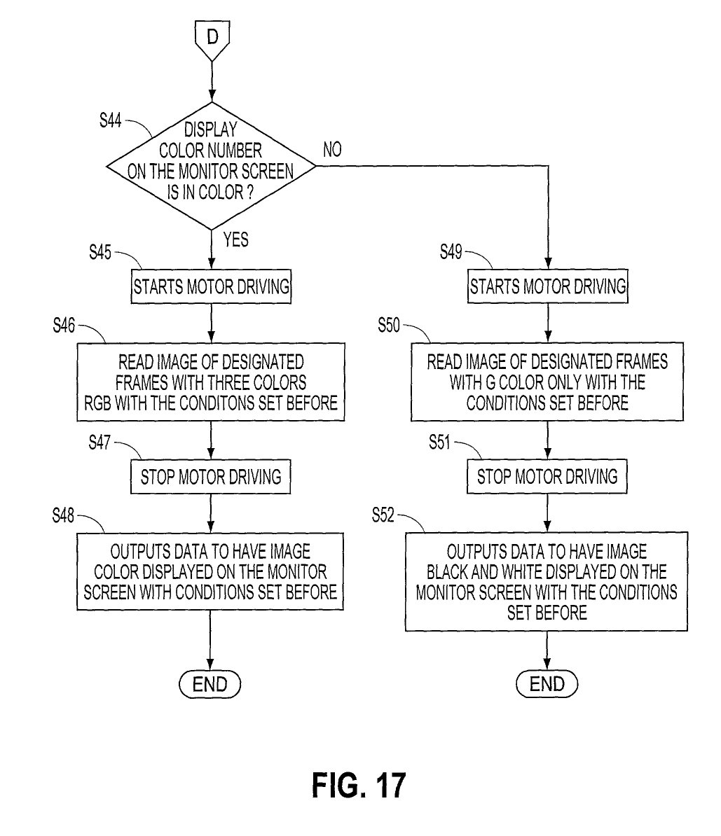

If the determination at S32 is affirmative (YES), the CPU 1 moves to the process at S33. If the determination at S32 is negative (NO), the CPU 1 moves to the process at S44 (FIG. 17). The process at S44 will be explained later.

At S33 the CPU 1 determines whether or not the display color number of the monitor screen is in color. If the display color number of the monitor screen is in color, the CPU 1 makes an affirmative (YES) determination. If the display color number of the monitor screen does not indicate color, the CPU 1 makes a negative (NO) determination.

If the determination at S33 is affirmative (YES), the CPU 1 completes the process by executing the color image display data generation process for all the frames which were shot in S34-S38. If the determination at S33 is negative (NO), the CPU 1 completes the process by executing the black and white image display data generation process for all the frames which were shot in S39-S43.

The color image display data generation process at S34-S38 is executed as follows. At S34 the CPU 1 begins rotation drive of the motor 16. At S35 the CPU 1 detects the number of frames which have shot with three colors R, G, B under the conditions that were previously set. At S36 the CPU 1 reads the image of all the frames which were shot by three colors R, G and B with the conditions that were previously set. The color reading method of the image will be explained later in FIG. 23(a), FIG. 24(a) and FIG. 25.

At S37 the CPU 1 stops rotation driving of the motor 16. At S38 the CPU 1 outputs image data to be color-displayed on the monitor screen, with the conditions that were previously set, to the host computer 19.

The black and white image display data generation process of S39-S43 is executed as follows. At S39 the CPU 1 starts rotation driving of the motor 16. At S40 the CPU 1 detects the number of frames which have already been shot. At S41 the CPU 1 reads images of all the frames which have been shot with only G color, with the conditions that were set before. The method of black and white reading of the image will be described in FIG. 23(b), FIG. 24(b) and FIG. 26.

At S42 the CPU 1 stops rotation driving of the motor 16. At S43 the CPU 1 outputs image data to be black and white displayed on the monitor screen, with the conditions that were previously set, to the host computer 19.

At S25, S29, S36 and S41 the CPU 1 decides the display size for each frame, based on the relationship between the number of frames to be displayed and the size of the monitor screen. Moreover, the CPU 1 sets the reading resolution so that the display size of each frame becomes optimum. The CPU 1 executes reading with the reading resolution established above.

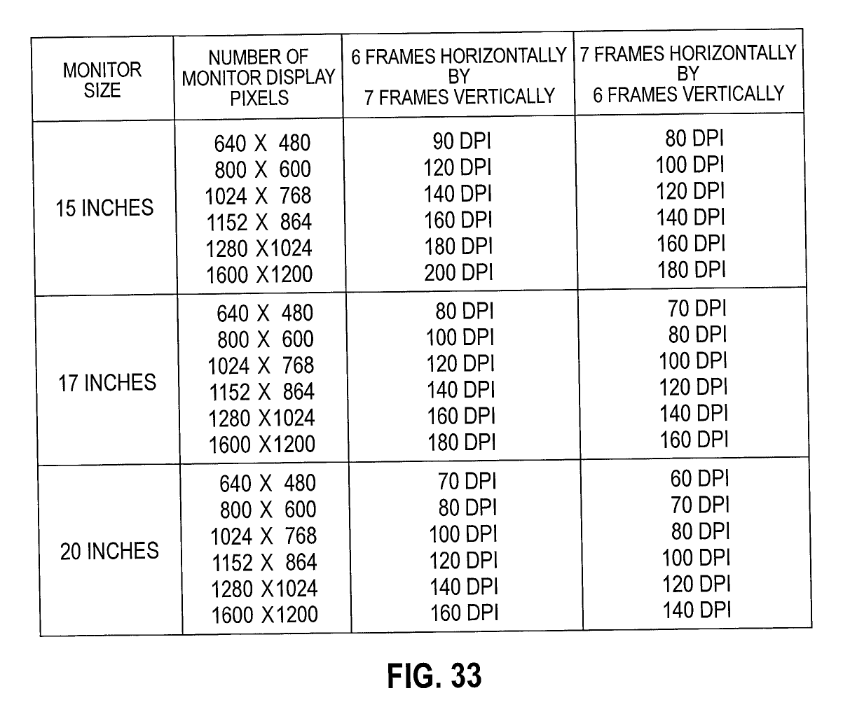

Next, the method of setting the reading resolution based on the number of frames to be displayed, the size of the monitor and the number of monitor display pixels will be described in reference to FIG. 33.

The CPU 1 recognizes the monitor size and the number of the monitor display pixels which are obtained at S1. Then the CPU 1 recognizes the width-to-length ratio of the display frame obtained at S3. The width-to-length ratio of the display frame is set by the user in the width-to-length ratio column in 1-3, “Display of the Index Display Setting” field of FIG. 8.

The CPU 1 determines the reading resolution by referring to a table, like the one shown in FIG. 33, which is stored in the memory 2. For simplicity of explanation, only the case in which the width-to-length ratio of the display is frames horizontally and frames vertically and the case in which the frames horizontally and 6 frames vertically are used in the table in FIG. 33.

The CPU 1 sets the reading resolution to be 120 dpi, for example, if the monitor size is 15 inches, the number of monitor display pixels is 800×600 and the width-to-length ration is 6 frames horizontally and 7 frames vertically. Reading range of each frame during index display is set at 27.4×15.6 mm. When an image is read with a reading resolution based on the table in FIG. 33, the index display of each frame is displayed with a size of about 1.7 inch horizontally and about 1 inch vertically on the monitor. An image with the size of this dimension may easily be distinguished by the user.

Now, suppose a display of 640×480 dots is made in a 20 inch monitor. If an image is read with 70 dpi resolution under conditions described above, the one frame of index is displayed with a size of 1.77 inches horizontally and 1.1 inches vertically on the monitor.

On the other hand, suppose a display is made with 640×480 dots in the 15 inch monitor. If an image is read with 70 dpi resolution under these conditions, the one frame of index is displayed with a size of 1.33 inches horizontally and 0.8 inches vertically on the monitor. The image becomes too small and is too difficult to be distinguished.

Thus, if an image is read by changing the resolution as described above, the user may easily distinguish the image even if the number of monitor display pixels is set large in a small monitor. The invention is not limited to the above example.

The reading resolution may be changed based on the number of the monitor display pixels in the case of reading with high resolution. For example, if the resolution is high, one image may not be completely displayed on the monitor. In this case the CPU 1 may set an upper limit of the reading resolution according to the monitor resolution obtained from the host computer 19. In other words, the reading resolution may be set so that the CPU 1 outputs the number of pixels no larger than the number of display pixels of the monitor. By doing this, the problem of one image not completely being displayed on the monitor is resolved.

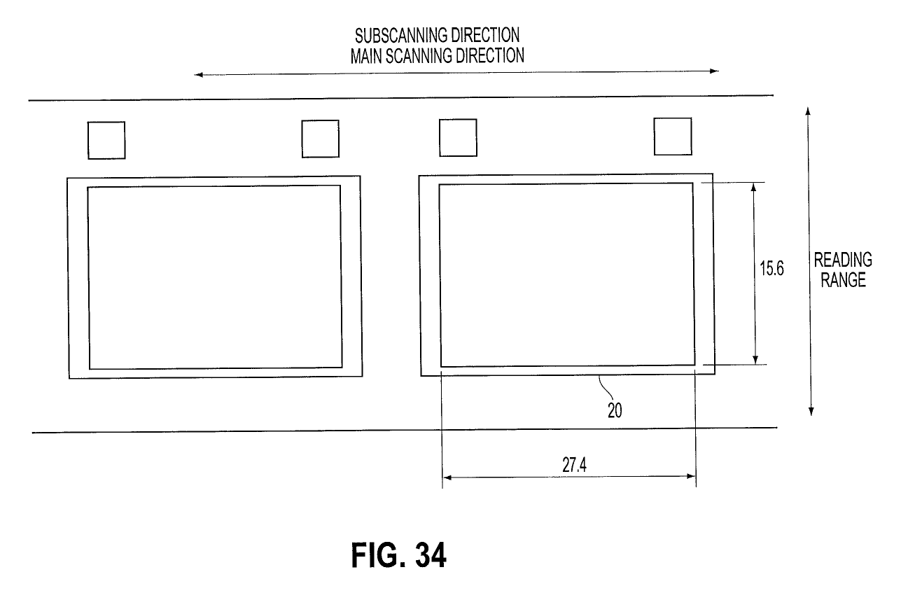

Reading resolutions in the main scanning direction and subscanning direction, and actual reading process will now be described. Here, the motor 16 is assumed to be a stepping motor. The number of effective pixels of the line sensor is 2500 pixels. Moreover, as described in FIG. 34, the actual range that the image reading apparatus reads the image in the image memory region 20 is assumed to be 27.4 mm×15.6 mm.

If the reading range in the main scanning direction is 15.6 mm and the number of effective pixels of the line sensor is 2500 pixels, the maximum resolution in the main scanning direction becomes 4070 dpi. If the resolution of the subscanning direction is assumed also to be 4070 pdi, the feeding amount per a line becomes 6 μm. The feeding amount per line means a shift amount of the reading range on the medium between the previous line and the current line. Assuming that the motor 16 feeds one line for each step, the motor 16 is preset so that the feeding amount of one step becomes 6 μm. By doing this the maximum resolution of the image reading becomes 4070 dpi for both the main scanning direction and the subscanning direction.

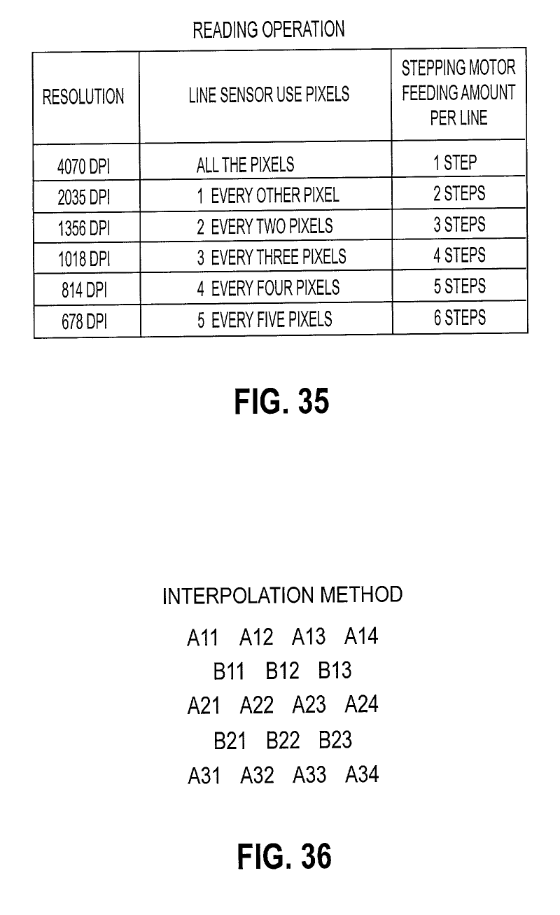

Next, the reading operation in the main scanning direction and subscanning direction with a set resolution will be described. Referring to FIG. 35, the CPU 1 performs the following setting when the reading is set for the maximum resolution of 4070 dpi. For the reading in the main scanning direction, the CPU 1 sets all the data of 2500 effective pixels which are output from the line sensor to be used for display. In other words, the CPU 1 sets all the data to be output to the host computer 19. Moreover, for the subscanning direction, the CPU 1 sets the feeding amount per one line of the stepping motor as one step.

For the main scanning direction, the CPU 1 sets the data obtained by selecting every whole number pixels out of 2500 effective pixels which are output from the line sensor to be output to the host computer 19. For the subscanning direction, the CPU 1 sets the feeding amount per one line of the stepping motor as the whole number multiple of one step.

For example, the CPU 1 performs the following setting when the reading is set for the resolution of 2035 dpi (which is half of the maximum resolution). For the reading in the main scanning direction, the CPU 1 sets every other data of 2500 effective pixels which are output from the line sensor to be used for display. In other words, the CPU 1 sets every other data to be output to the host computer 19. For the subscanning direction, the CPU 1 sets the feeding amount per one line of the stepping motor as two steps.

Next, when reading is set with a resolution obtained by dividing the maximum resolution with a number other than a whole number, the CPU 1 performs the following steps. The CPU 1 sets so that the image is read with the resolution which is obtained by dividing the set resolution by the closest whole number smaller than the divider. Moreover, an interpolation algorithm is set for the CPU 1 to execute on the data obtained. When the CPU 1 executes the interpolation algorithm, the image data having the set reading resolution is obtained.

For example, a case in which reading resolution is set as 3000 dpi will be described. The CPU 1 sets the actual reading resolution as 4070 pdi. The CPU 1 then sets an interpolation algorithm to interpolate from 4070 dpi to 3000 dpi. The CPU 1 executes the interpolation algorithm process on the output of the A/D converter 8 during the image reading process to obtain image data with 3000 dpi.

An example of the interpolation method will be now described. The number of pixels in 4070 dpi is 2500×4391 while the number of pixels, 3000 dpi, is 1843×3236. In other words, for the main scanning direction, the CPU 1 executes the interpolation algorithm to make 2500 pixels into 1843 pixels. Moreover, in the subscanning direction, the CPU 1 executes the interpolation algorithm so that 4391 pixels become 3236 pixels.

The interpolation method is described in reference to FIG. 36. FIG. 36 denotes 4070 dpi data as Axx and 3000 dpi data as Bxx. For example, the CPU 1 sets weighted coefficients for B12 which are proportional to distances from each pixel of A12, A13, A22, and A23 to B12. Then the CPU 1 multiplies the weighted coefficients to each of A12, A13, A22 and A23, and each product is added. As a result the host computer, which receives output from S27, S31, S38 and S43, displays the image only index field for all the frames or all the frames that have been shot. FIG. 27 is an example of an image only index field for all the frames.

The user may set the frame number in the column, “frame to be scanned” after observing the index field. The user may also set the frame number under the column “frame to be scanned” by clicking the mouse on the image section or the number section of the frame in the index field. If the frame number, which is set in the column, (“frame to be scanned”) needs to be canceled, the user operates the “cancel” button.

The host computer 19, responding to operation of the “SCAN” button by the user, gives the frame number which is set in the column, “frame to be scanned” to IF circuit 3. Through this process the CPU 1 knows the frame on which to execute main scanning.

Next, at S44 the CPU 1 determines whether or not the display color number in the monitor screen is in color in order to execute display data generation process for a designated frame. If the display color number of the monitor screen indicates color, the CPU 1 makes an affirmative (YES) determination. If the display color number of the monitor screen does not indicate color, the CPU 1 makes a negative (NO) determination.

If the determination at S44 is affirmative (YES), the CPU 1 completes the process by executing color image display data generation process for a designated frame at S45-S48. If the determination at S44 is negative (NO), the CPU 1 completes the process by executing the black and white image display data generation process for the designated frame at S49-S52.

The color image display data generation process at S45-S48 is executed as follows. At S45 the CPU 1 starts rotation driving of the motor 16. At S46 the CPU 1 reads image of the designated frame with three colors R, G and B under the data conditions previously set.

For example, at S46 the CPU 1 moves the medium so that each selected frame reaches the reading position of the line sensor 12, based on detection signals from the medium position detection sensor 13. Moreover, the CPU 1 selects the frame which matches a designation such as “H size only”, “C size only”, “P size only”, “Horizontal Position Only” and “Vertical Position Only”. The color reading method of the image will be described in reference to FIG. 23(a), FIG. 24(a) and FIG. 25.

At S47 the CPU 1 stops the rotation driving of the motor 16. At S48 the CPU 1 outputs the image data to be color displayed on the monitor screen to the host computer 19, with the conditions that were previously set.

The black and white image display data generation process of S49-S52 are executed as follows. At S49 the CPU 1 starts rotation driving of the motor 16. At S50 the CPU 1 reads the image of the designated frame using only color G with the conditions which were previously set. Black and white reading of the image will be described in reference to FIG. 23(b), FIG. 24(b) and FIG. 26.

At S51 the CPU 1 stops rotation driving of the motor 16. At S52 the CPU 1 sends the image data to be black and white displayed on the monitor screen to the host computer 19, with the conditions that were previously set.

At S46 and S50, depending on the relationship between the number of designated frames and the monitor size, the CPU 1 may establish reading resolution. The establishment of reading resolution takes the frame display size into consideration.

At S48 and S52 the CPU 1 reads and outputs a designated number of frames to be displayed at high speed, if the data to be displayed is “high speed display”. Responding to this, the host computer 19 displays the index field of the designated frame image such as described in FIG. 28.

When the user operates the left and right mouse buttons in the field of FIG. 28, the host computer 19 outputs to the reading apparatus a designated number of frames to be displayed at high speed. The CPU 1 then reads and outputs the designated number of frames to be displayed at high speed. As a result, if the number of frames is 6, the 6 designated frames are displayed one after another each time the mouse is operated in accordance with the above instructions.

The user, observing the index field, sets the frame number “frame to be scanned” column. The host computer 19, responding to the operation of the “SCAN” button by the user, gives the frame number to IF circuit 3. Through this process the CPU 1 realizes the frame for which main scanning is executed.

The image reading method is as follows. Color reading of an image to be executed at S25, S36 and S46 will use one of three methods described in FIG. 23(a), FIG. 24(a) and FIG. 25.

FIG. 23 (a) describes an image reading method of one path method in which a light source that can turn on R (red), G (green) and B (blue) interchangeably and a black and white image sensor is used. The black and white image sensor is a line sensor. In the method described in FIG. 23(a), the light source is turned on for each line by switching in order from R (red), G (green) and B (blue) and one field is read by one movement of medium.

FIG. 24(a) describes an image reading method of one path method in which a white-color light source and a color image sensor is used. The color image sensor is a line sensor. The color image sensor executes reading of R (red), G (green) and B (blue) for each line, and one field is read by one movement of medium.

FIG. 25 describes a method in which the image is read by a three-path method using a white-color light source, a black and white image sensor which is a line sensor and an RGB filter and its switching mechanism. Switching of the RGB filter is executed every time reading of the first line to the last line is completed in the reading of one field. Thus, in this method reading of one field is accomplished by three movements of the medium.

The black and white reading of the image executed at S29, S41 and S50 is accomplished by one of three methods described in FIG. 23(b), FIG. 24(b) and FIG. 26.

FIG. 23(b) describes an image reading method of one path in which a G (green) light source of the light source that can turn on R (red), G (green) and B (blue) interchangeably and a black and white image sensor, which is a line sensor, is used. Each line is read using G (green) light source only. Reading of one field is completed with one movement of medium. In the black and white reading method switching of the light source is not executed, but only the G (green) light source is used. Thus, high speed reading becomes possible compared to the color reading method described in FIG. 23(a).

FIG. 24 (b) describes an image reading method of one path method in which a white-color light source and a color image sensor is used. The color image sensor is a line sensor. In FIG. 24 (b) the data delivered to the host computer 19 is only G (green) color among three colors of image data which are read. The black and white reading method in which the color image sensor is used as a line sensor reduces data volume to be delivered to the host computer 19. This reduction is equivalent to one third of the data volume in the case of color reading. Thus, data transfer time to the host computer 19 and the data processing time will be reduced substantially. Therefore, the entire reading is at a higher speed than the case of color reading.

FIG. 26 describes the image reading method with one path using white-color light resource, a black and white image sensor (which is an image sensor) and G filter. Using this method, the G filter is selected and used among RGB filters in the same structure as described in FIG. 25. Thus, reading of one field is completed by one movement of the medium. For this reason, the black and white reading method described in FIG. 26 enables higher speed reading than the color reading method described in FIG. 25.

Next at S53, the CPU 1 determines whether or not “image display” is selected in the index display setting field. If “image display” has been selected, the CPU 1 makes an affirmative (YES) determination. In this case both “magnetic information display” and “image display” are selected. If the “image display” is not selected, the CPU 1 makes a negative (NO) determination. In this case selection of “display of magnetic information only” is selected.

If the determination at S53 is affirmative (YES), the CPU 1 moves to the process at S69. If the determination at S53 is negative (NO), the CPU 1 executes display data generation process of magnetic information only, at S54-S68.

At S54 the CPU 1 determines whether or not “all frame display” is selected. If “all frame display” is selected the CPU 1 makes an affirmative (YES) determination. If “all frame display” is not selected the CPU 1 makes a negative (NO) determination.

If the determination at S54 is affirmative (YES), the CPU 1 executes the magnetic information display data generation process of all the frames and the present process is completed. If the determination at S54 is negative (NO), the CPU 1 moves to processing at S59 (FIG. 18). The process of S59 will be explained below.

The magnetic information display data generation process for all the frames at S55-S58 is executed as follows. At S55 the CPU 1 starts rotation driving of the motor 16. At S56 the CPU 1 reads the magnetic information of all the frames, with the conditions that were previously set.

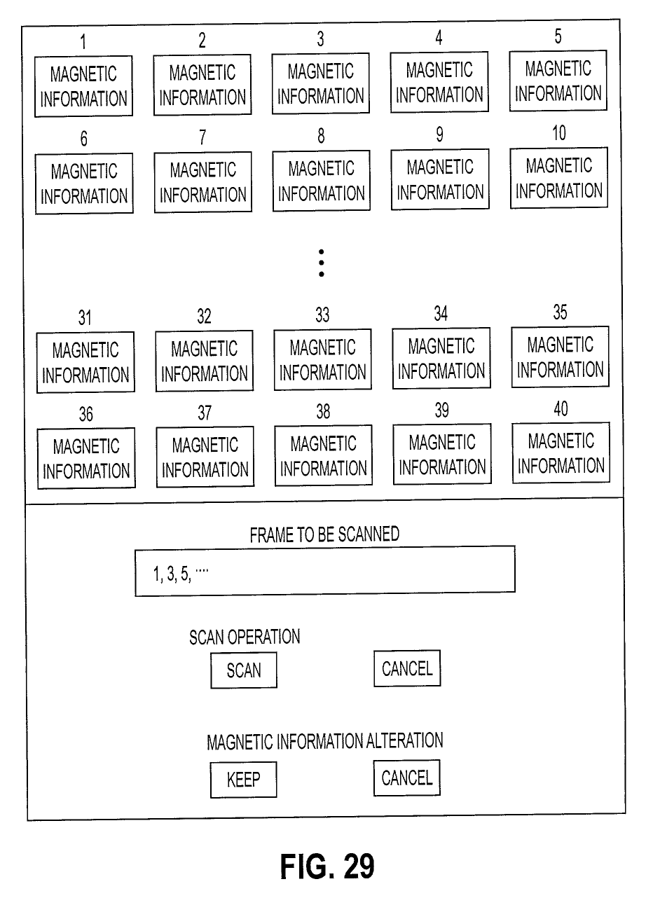

At S57 the CPU 1 stops rotation driving of the motor 16. At S58 the CPU 1 outputs to the host computer 19 the magnetic information data to be displayed on the monitor screen with the conditions that were previously set. As a result, the host computer 19 displays the index field of magnetic information only on the monitor screen, such as one described in FIG. 29. The user, observing the index field, can set the frame number in the “frame to be scanned” column. The user can also set the frame number in the “frame to be scanned” column, by clicking the number section and the magnetic information section of the index field with the mouse.

The host computer 19, in response to users operation of the “SCAN” button, gives the frame number, which is set in the “frame to be scanned” column, to IF circuit 3. By this process the CPU 1 knows the frame for which main scanning is to be executed.

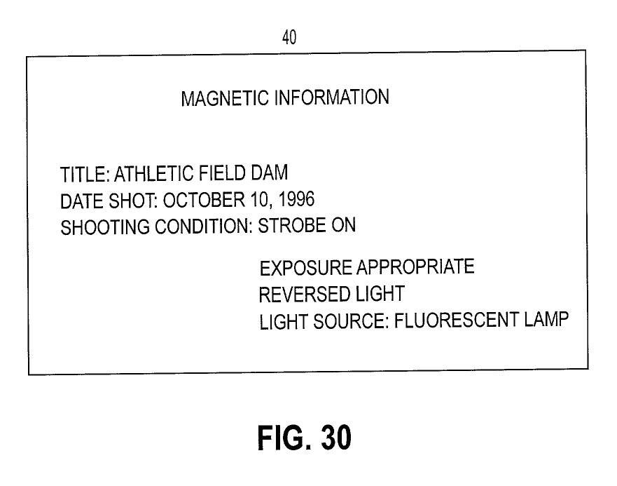

As described in FIG. 30, the user can magnify and display the magnetic information display of the frame. The contents of the magnetic information are, title, date of shooting, shooting conditions and similar information. Shooting conditions include, whether or not a strobe is used, whether or not light is reversed, types of light sources and similar information. Verification of these choices becomes easy as a result of the magnified display.

The user can add corrections or additions to the contents of the magnetic information. This altering operation becomes easier by the magnification display described above. Contents of alterations are maintained in the host computer 19 by operation of the “keep” button described in FIG. 29. The host computer 19 gives the contents of the alteration to IF circuit 3. Through this process the CPU 1 learns of the alterations to the magnetic information.

At S59 the CPU 1 determines whether or not “display of all the frames which are shot” is selected. If the “display of all the frames which are shot” is selected, the CPU 1 makes an affirmative (YES) determination. If the “display of all the frames which are shot” is not selected, the CPU 1 makes a negative (NO) determination. In this case “selection frame” is selected. This indicates that the process for the selected designated frame is being executed.

If the determination at S59 is affirmative (YES), the CPU 1 completes the present operation by executing the magnetic information display data generation process for the frames which were shot at S62-64. If the determination at S59 is negative (NO), the CPU 1 completes the present operation by executing the magnetic information display data generation process for the frames which were designated at S65-68.

The magnetic information display data generation process for the frames which have been shot is executed in steps S60-S64. At S60 the CPU 1 starts rotation driving of the motor 16. At S61 the CPU 1 detects the number of frames which have been shot. At S62 the CPU 1 reads the magnetic information of all the frames which have been shot with the conditions previously set. At S63 the CPU 1 stops the rotation driving of the motor 16. At S64 the CPU 1 outputs to the host computer 19 the magnetic information data to be displayed on the monitor screen, with the conditions previously set.

As a result, the host computer 19 displays the magnetic information of the frames which have been shot. In this case, the display format is the same as the display format of the image of the frames which have been shot (FIG. 27). Magnified display and alterations are now possible.

The magnetic information display data generation process for the designated frames is executed in steps S65-S68. At S65 the CPU 1 starts rotation driving of the motor 16. At S66 the CPU 1 reads the magnetic information of the designated frames with the conditions that were previously set. At S67 the CPU 1 stops rotation driving of the motor 16. At S68 the CPU 1 outputs the magnetic information data to the host computer 19. This data is displayed on the monitor screen with the conditions which were previously set.

As a result, the host computer 19 displays the magnetic information of the designated frame. In this case, the display format is the same as the display format as the designated frame image (FIG. 28). Magnified display and alterations are now possible.

FIGS. 20-22 describe the display data generation process for the case in which both “magnetic information display” and “image display” are selected.

At S69 the CPU 1 determines whether or not “all frame display” is selected. If “all frame display” is selected, the CPU 1 makes an affirmative (YES) determination. If “all frame display” is not selected, the CPU 1 makes a negative (NO) determination.

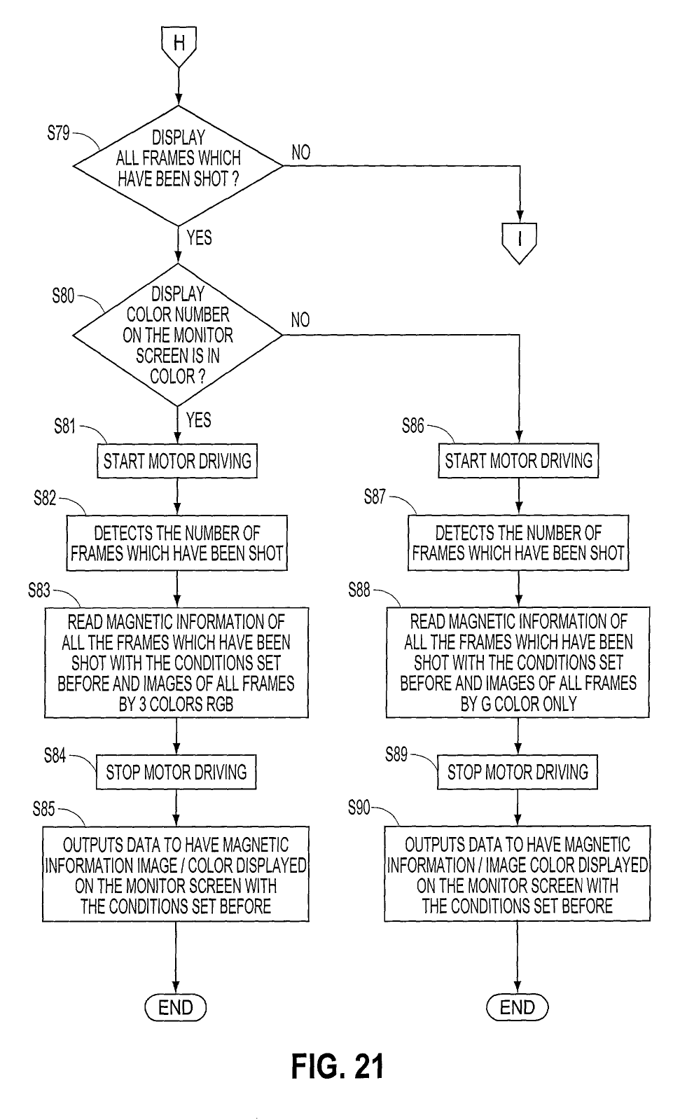

If the determination at S69 is affirmative (YES), the CPU 1 moves to S70. If the determination at S69 is negative (NO), the CPU 1 moves to S79 (FIG. 21). The process at S79 will be explained later.

At S70 the CPU 1 determines whether or not the display color number on the monitor screen is in color. If the display color number on the monitor screen is in color, the CPU 1 makes an affirmative (YES) determination. If the display color number on the monitor screen does not indicate color, the CPU 1 makes a negative (NO) determination.

If the determination at S70 is affirmative (YES), the CPU 1 completes the present process by executing the color display data generation process at S71-S74. If the determination at S70 is negative (NO), the CPU 1 completes the present process by executing the black and white display data generation process at S75-S78.

At S71-S74 the color display data generation process is executed. At S71 the CPU 1 starts the rotation driving of motor 16. At S72 the CPU 1 reads the magnetic information and images of all the frames with three colors R, G and B, with the conditions that were previously set. At S73 the CPU 1 stops the rotation driving of the motor 16. At S74 the CPU 1 outputs to the host computer 19 the magnetic information and image data to be color displayed on the monitor screen with the conditions that were previously set.

At S75-S78 the black and white display data generation process is executed. At S75 the CPU 1 starts the rotation driving of the motor 16. At S76 the CPU 1 reads magnetic information and images of all the frames with only G color, with the conditions that were previously set. At step 77 the CPU 1 stops rotation driving of the motor 17. At S78 the CPU 1 outputs to the host computer 19 the magnetic information and image data to be black and white displayed on the monitor screen, with the conditions that were previously set.

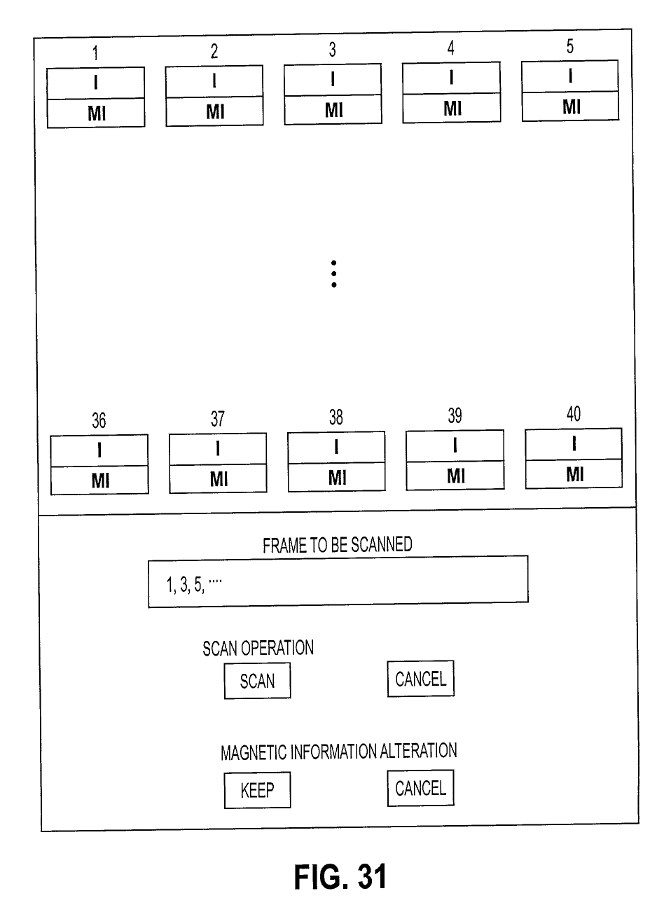

As a result, the host computer 19 displays on the monitor screen an index field in which magnetic information and images for each frame is combined, such as the one described in FIG. 31. The user, observing the index field, can set the frame number in the “frame to be scanned” column. The user can also set the frame number in the “frame to be scanned” column, by clicking the number section and the image section of the index field.

The host computer 19, in response to the user's operation of the “SCAN” button, gives the frame number, which is set in the “frame to be scanned” column, to IF circuit 3. By this process the CPU 1 knows the frame for which the main scanning is executed.

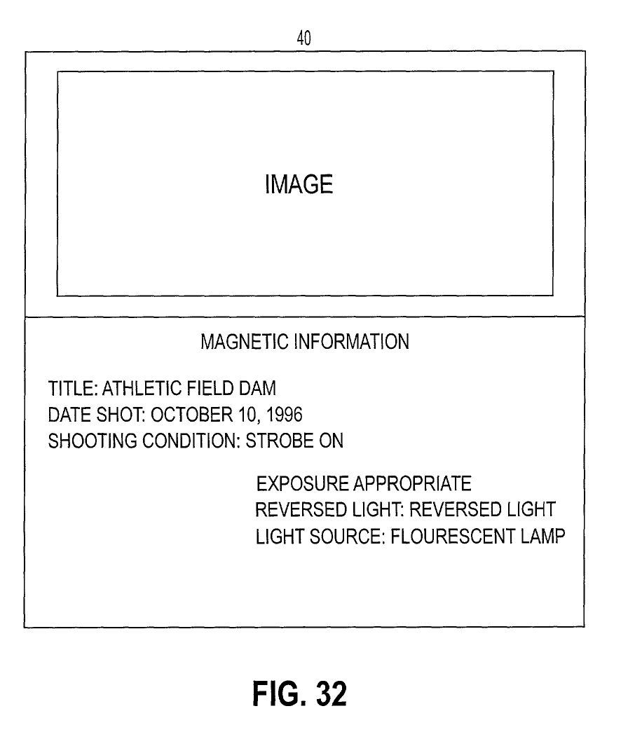

As described in FIG. 32, by clicking an arbitrary frame the user can magnify and display the magnetic information display of the frame. The contents of the magnetic information are title, date of shooting, shooting conditions and other similar information. Shooting conditions include, whether or not a strobe is used, whether or not light is reversed, types of light sources and other similar information.

The user can also add corrections or additions to the contents of the magnetic information. This altering operation becomes easier by use of the magnification display described above. Contents of alterations are maintained in the host computer 19 by operation of the “Keep” button. The host computer 19 gives the contents of the alteration to IF circuit 3. Through this process the CPU 1 learns of the alterations to the magnetic information.

At S79 the CPU 1 determines whether or not “display of all the frames which are shot” is selected. If the “display of all the frames which are shot” is selected, the CPU 1 makes an affirmative (YES) determination. If the “display of all the frames which are shot” is not selected, the CPU 1 makes a negative (NO) determination. In this case “selection frame” is selected. This indicates that the process for the selected designated frame is being executed.

If the determination at S79 is affirmative (YES), the CPU 1 moves to the process at S80. If the 25 determination at S79 is negative (NO), the CPU 1 moves to the process at S91 (FIG. 22). The process at S91 will be explained later.

At S80 the CPU 1 determines whether or not the display color number on the monitor screen is in color. If the display color number on the monitor screen indicates color, the CPU 1 makes an affirmative (YES) determination. If the display color number on the monitor screen does not indicate color, the CPU 1 makes a negative (NO) determination.

If the determination at S80 is affirmative (YES), the CPU 1 completes the present process by executing the color display data generation process at S81-S85. If the determination at S80 is negative (NO), the CPU 1 completes the present process by executing the black and white display data generation process at S86-S90.

At S81-S85 the color display data generation process is executed. At S81 the CPU 1 starts the rotation driving of motor 16. At S82 the CPU 1 detects the number of frames which have been shot. At S83 the CPU 1 reads the magnetic information of all the frames which were shot with the previously set conditions and images of all the frames which were shot with three colors, RGB. At S84 the CPU 1 stops rotation driving of the motor 16. At S85 the CPU 1 outputs to the host computer 19 the magnetic information and image data to be color displayed on the monitor screen, with the conditions that were previously set.

At S86-S90 the black and white display data generation process is executed. At S86 the CPU 1 starts the rotation driving of motor 16. At S87 the CPU 1 detects the number of frames which have been shot. At S88 the CPU 1 reads the magnetic information of all the frames which were shot with the conditions previously set and images of all the frames which were shot with G color only. At S89 the CPU 1 stops the rotation driving of the motor 16. At S90 the CPU 1 outputs to the host computer 19 the magnetic information and image data to be black and white displayed on the monitor screen, with the conditions that were previously set.

As a result, the monitor screen for the magnetic information and the image of each frame with a similar format as the one described above is displayed on the host computer 19. The user is able to execute operations similar to that described before.

At S91, the CPU 1 determines whether or not the display color number on the monitor screen is in color in order to execute the display data generation process of the designated frame. The CPU 1 makes an affirmative (YES) determination if the display color number on the monitor screen is in color. The CPU 1 makes a negative (NO) determination if the display color number on the monitor screen is not in color.

If the determination at S91 is affirmative (YES), the CPU 1 completes the present process by executing the color display data generation process at S92-S95. If the determination at S91 is negative (NO), the CPU 1 completes the present process by executing the black and white display data generation process at S96-S99.

At S92-S95 the color display data generation process is executed. At S92 the CPU 1 starts the rotation driving of motor 16. At S93 the CPU 1 reads the magnetic information of designated frames with the conditions that were previously set and the image of designated frames with three colors, RGB. At S94 the CPU 1 stops the rotation driving of the motor 16. At S95 the CPU 1 outputs to the host computer 19 the magnetic information and image data to be color displayed on the monitor screen, with the conditions that were previously set.

At S96-S99 the black and white display data generation process is executed. At S96 the CPU 1 starts the rotation driving of the motor 16. At S97 the CPU 1 reads the magnetic information of designated frames with the previously set conditions and the image of designated frames, with G color only. At S98 the CPU 1 stops the rotation driving of the motor 16. At S99 the CPU 1 outputs to the host computer 19 the magnetic information and image data to be black and white displayed on the monitor screen, with the conditions that were previously set.

As a result, the host computer 19 displays on the monitor screen the magnetic information and the image of each designated frame with a similar format as described above. The user is also able to execute operations similar to those apertures stated before.

Image reading at S72, S76, S83, S88, S93, and S97 is executed by the method described in FIGS. 23-26, as described above. As previously explained, the reading resolution is set by considering the relationship between the display frame number and the monitor size.

The control program of the host computer 19 in the embodiment described above is stored in a hard disk drive which is a recording medium. The program may be stored beforehand in a recording medium 19a such as a CD-ROM to enable setup in the host computer 19.

The CPU 1 of the image reading apparatus may be used in place of the CPU of the host computer 19. Moreover, the memory 2 of the image reading apparatus may be used in place of the memory of the host computer 19. In this case, programs which are the same as the programs in the host computer 19 need to be stored in ROM (program memory). By reading the programs stored in ROM to the working memory, the CPU 1 of the image reading apparatus is able to execute the programs.

While this invention has been described in conjunction with specific embodiments thereof, it is evident that many alternatives, modifications and variations will be apparent to those skilled in the art. Accordingly, the preferred embodiments of the invention as set forth herein are intended to be illustrative, not limiting. Various changes may be made without departing from the spirit and scope of the invention as defined in the following claims.

What is claimed is:

1. An image reading device for use with a host apparatus having a monitor screen, the image reading device comprising:
an illumination device to illuminate an original;
an image reading device coupled to the illumination device, the image reading device photo-electrical converting light from the original and outputting an image signal;
a moving device to move at least one of the original and the image reading device;
a data generation device to generate index display image data by receiving the output from the image reading device;
a size data obtaining device to obtain size data of the monitor screen of the host apparatus; and
a control device coupled to the image reading device, the control device setting a reading resolution based on a relationship between a number of frames to be index displayed and the size data of the monitor screen, and to cause the image reading device to execute conversion operation with the set reading resolution.

2. An image reading device for use with a host apparatus having a monitor screen, the image reading device comprising:
an illumination device to illuminate an original;
a display color obtaining device to obtain a number of display colors for the monitor screen of the host apparatus;
an image reading device coupled to the illumination device, the image reading device photo-electric converting light from the original and outputting an image signal;
a moving device to move at least one of the original and the image reading device; and
a control device coupled to the image reading device, the control device controlling the image reading device for executing a conversion operation to the image signals with a number of display colors that is consistent with the number of display colors obtained by the display color obtaining device.

3. A storage medium that stores a control process for an image reading device, the image reading device comprising an illumination device to illuminate an original; an image reading device coupled to the illumination device, the image reading device photo-electric converting light from the original and outputting an image signal; and a moving device to move at least one of the original and the image reading device, wherein the control process comprises:
generating index display image data by receiving output from the image reading device;
obtaining size data of the monitor screen of the host apparatus;
setting a reading resolution based on the relationship between the number of frames to be index displayed and the size data of the monitor screen; and
causing the image reading device to execute a conversion operation with the set reading resolution.

4. A storage medium that stores a control process for an image reading device, the image reading device comprising an illumination device to illuminate an original; a display color obtaining device to obtain a number of display colors for a monitor screen of a host apparatus; an image reading device photo-electric converting light from the original and outputting an image signal; and a moving device to move at least one of the original and the image reading device, wherein the control process comprises:
causing the image reading device to execute a conversion operation to the image signals with a number of display colors that is consistent with the number of display colors obtained by the display color obtaining device.

5. An image reading device for use with a host apparatus having a monitor screen, the image reading device comprising:
illumination means for emitting light, the illumination means illuminating an original;
image reading means for photo-electric converting light from the original and outputting an image signal;
moving means for moving at least one of the original and the image reading means;
data generation means for generating index display image data by receiving the output from the image reading means;
size data obtaining means for obtaining size data of the monitor screen of the host apparatus; and
control means for setting a reading resolution based on a relationship between a number of frames to be index displayed and the size data obtained from the monitor screen.

6. The image reading device of claim 5, wherein the image reading means outputting the image signal by scanning in a main scanning direction, and said moving means moving at least one of the original and the image reading means in a subscanning direction which intersects with the main scanning direction.

7. The image reading device of claim 5, wherein the image reading means executes a conversion operation with the set reading resolution.

8. The image reading device of claim 5, wherein the original includes a plurality of memory regions, and the image reading means converts an image in each of the image memory regions of the original to the image signal.

9. The image reading device of claim 5, further comprising display color obtaining means for obtaining a number of display colors for the monitor screen of the host apparatus.

10. The image reading device of claim 9, wherein the image reading means executes a conversion operation to the image signal with a number of display colors that is consistent with the number of display colors obtained by the display color obtaining means.

11. The image reading device of claim 5, further comprising a storage medium that stores at least one control process for the image reading means.

12. The image reading device of claim 5, further comprising a color separating means that chromatically separates the image of the original.

13. An image reading device for use with an original and a host apparatus having a monitor screen, the image reading device comprising:
illumination means for emitting light, the illumination means illuminating the original;
display color obtaining means for obtaining a number of display colors for the monitor screen of the host apparatus;
image reading means for photo-electric converting light from the original and outputting an image signal;
moving means for moving at least one of the original and the image reading means; and
control means for causing the image reading means to execute a conversion operation to the image signals with a number of display colors that is consistent with the number of display colors obtained by the display color obtaining means.

14. The image reading device of claim 13, wherein the image reading means outputting the image signal by scanning in a main scanning direction, and the moving means moving at least one of the original and the image reading means in a subscanning direction which intersects with the main scanning direction.

15. The image reading device of claim 14, further comprising a storage medium which stores a control process, said control process comprising:
generating index display image data by receiving output from the image reading means;
obtaining size data of the monitor screen of the host apparatus; and
setting a reading resolution on the monitor screen of the host apparatus based on a relationship between a number of frames to be index displayed and the size data of the monitor screen.

16. The image reading device of claim 15, wherein the storage medium further comprises a control processor to cause the image reading means to execute a conversion operation to the image signal with a number of display colors that is consistent with the number of display colors obtained by the display color obtaining means.

17. A method of reading an original, an image of the original being displayed on a monitor screen of a host apparatus, the method comprising:
emitting light for illuminating the original;
photo-electric converting light from the original;
outputting an image signal;
generating index display image data by receiving the image signal;
obtaining size data of the monitor screen of the host apparatus; and
setting a reading resolution based on a relationship between a number of frames to be index displayed and size data obtained from the monitor screen.

18. The method of claim 17, wherein the photo-electric converting includes converting an image in each of the image memory regions of the film original to the image signal.

19. The method of claim 17, further comprising obtaining a number of display colors of the monitor screen of the host apparatus.

20. A method of reading an original, an image of the original being displayed on a monitor screen of a host apparatus, the method comprising:
obtaining a number of display colors for the monitor screen of a host apparatus;
photo-electric converting light from the original;
outputting image signals; and
executing a conversion operation to the image signal with a number of display colors that is consistent with the number of obtained display colors.
